(19) United States
(12) Patent Application Publication
(10) Pub. No.: US 2025/0184969 A1
(43) Pub. Date: Jun. 5, 2025

(54) Methods for Enhanced Resource Allocation in Wireless Communication Systems

(71) Applicant: Apple Inc., Cupertino, CA (US)

(72) Inventor: Balaji Raao, San Diego, CA (US)

(21) Appl. No.: 18/815,545

(22) Filed: Aug. 26, 2024

Related U.S. Application Data
(60) Provisional application No. 63/604,631, filed on Nov. 30, 2023.

(51) Int. Cl. H04W 72/04; H04L 5/00

(52) U.S. Cl. CPC H04W 72/04; H04L 5/0091

(57) ABSTRACT

A method can include establishing a wireless link with a Fifth Generation (5G) New Radio (NR) network node and receiving signaling including an indication of a resource allocation type for allocated 5G NR physical downlink shared channel (PDSCH) resources in a downlink (DL) slot. The method can include determining the resource allocation type and performing a first computation of a resource block (RB) bitmap and a second computation of at least one of resource block group (RBG) parameters or resource block bundle (RBB) parameters for the determined resource allocation type. The method can also include performing, using the RB bitmap and at least one of the RBG or RBB parameters for the determined resource allocation type, a third computation of an order of physical resource blocks (PRBs) for the allocated 5G NR PDSCH resources and generating signaling according to the order of PRBs for the allocated 5G NR PDSCH resources.

### PRIORITY INFORMATION

This application claims priority to U.S. Provisional Patent Application No. 63/604,631, entitled “Methods for Enhanced Resource Allocation in Wireless Communication Systems,” filed Nov. 30, 2023, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The invention relates to wireless communications, and more particularly to apparatuses, systems, and methods for enhanced resource allocation in wireless communication systems.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include UMTS (associated with, for example, WCDMA or TD-SCDMA air interfaces), LTE, LTE Advanced (LTE-A), HSPA, IEEE 802.11 (WLAN or Wi-Fi), BLUETOOTH™, UWB, etc.

The ever-increasing number of features and functionalities introduced in wireless communication devices also create a continuous need for improvement in both wireless communications and in wireless communication devices. To increase coverage and better serve the increasing demand and range of envisioned uses of wireless communication, in addition to the communication standards mentioned above, there are further wireless communication technologies under development.

A proposed next telecommunications standard moving beyond the current International Mobile Telecommunications-Advanced (IMT-Advanced) Standards is called 5th generation mobile networks or 5th generation wireless systems, or 5G for short (otherwise known as 5G NR for 5G New Radio, also simply referred to as NR). 5G NR proposes a higher capacity for a higher density of mobile broadband users, also supporting device-to-device, ultra-reliable, and massive machine communications, as well as lower latency and lower battery consumption, than current LTE standards. Further, the 5G NR standard can allow for less restrictive UE scheduling as compared to current LTE standards. Consequently, efforts are being made in ongoing developments of 5G NR to take advantage of higher throughputs possible at higher frequencies. Accordingly, improvements in the field in support of such development and design are desired.

### SUMMARY

Embodiments relate to wireless communications, and more particularly to apparatuses, systems, and methods for enhanced resource allocation in wireless communication systems.

According to some embodiments, a method can include establishing a wireless link with a Fifth Generation (5G) New Radio (NR) network node and receiving, from the 5G NR network node, signaling comprising a field including an indication of a resource allocation type for allocated 5G NR physical downlink shared channel (PDSCH) resources in a downlink (DL) slot. The method can include determining, based on the indication, the resource allocation type and performing, using one or more first input parameters, a first computation of a resource block (RB) bitmap for the determined resource allocation type. Additionally, the method can include performing, using one or more second input parameters, a second computation of at least one of resource block group (RBG) parameters or resource block bundle (RBB) parameters for the determined resource allocation type. Furthermore, the method can include performing, using one or more third input parameters, the RB bitmap, and at least one of the RBG or RBB parameters for the determined resource allocation type, a third computation of an order of physical resource blocks (PRBs) for the allocated 5G NR PDSCH resources and generating signaling for transmission to the 5G NR network node according to the order of PRBs for the allocated 5G NR PDSCH resources.

In some embodiments, the determined resource allocation type can be resource allocation type-0 or resource allocation type-1. Additionally, the first and second computations can be compatible with both resource allocation type-0 and resource allocation type-1. According to some embodiments, the signaling can be downlink control information (DCI) or radio resource control (RRC) signaling.

According to some embodiments, the first computation can utilize arithmetic logical unit (ALU) operations including at least one of addition, subtraction, bit shift, bitwise AND, bitwise OR, or bitwise NOT operations. Additionally, the first computation can be utilized for multiple iterations to compute and update the RB bitmap for a maximum of 275 PRBs associated with a 32-bit word comprising an array of nine elements. Furthermore, the one or more first input parameters can include at least one of one or more parameters specifying at least one of dimensions or characteristics of an array associated with the RB bitmap, one or more parameters specifying a starting RB for the first computation, one or more parameters specifying a total number of RBs for the first computation, or one or more parameters specifying a mask of RBs associated with the RB bitmap, according to some embodiments. According to some embodiments, if the number of PRBs exceeds a word boundary of the 32-bit word, the first computation can update both lower and upper 32-bit words to compensate for crossover across the word boundary.

According to further embodiments, the second computation can utilize a modulo operation, an input nominal size being a power of 2, a ceil of a division operation, and ALU operations including at least one of addition, subtraction, bit shift, or bitwise AND to derive other parameters including a modulo mask and a modulo result. Additionally, the second computation can utilize a look-up table to implement a logarithm to base-2 operation. Furthermore, the one or more second input parameters can include at least one of one or more parameters specifying a starting RB for the second computation, one or more parameters specifying a size of a bandwidth part (BWP) for the second computation, one or more parameters specifying a size of a RBG for the second computation, or one or more parameters specifying an interleaver size in terms of PRBs for interleaving virtual resource blocks (VRBs) and PRBs for the second computation, according to some embodiments.

According to some embodiments, the RB bitmap can be an array of nine 32-bit words. Furthermore, the first and second computations can utilize ALU operations for preparation of the first and second input parameters and post-processing of output parameters, according to some embodiments.

The techniques described herein can be implemented in and/or used with a number of different types of devices, including but not limited to unmanned aerial vehicles (UAVs), unmanned aerial controllers (UACs), base stations, access points, cellular phones, tablet computers, wearable computing devices, portable media players, automobiles and/or motorized vehicles, and any of various other computing devices.

This Summary is intended to provide a brief overview of some of the subject matter described in this document. Accordingly, it will be appreciated that the above-described features are merely examples and may not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example wireless communication system, according to some embodiments;

FIG. 2 illustrates a base station (BS) in communication with a user equipment (UE) device, according to some embodiments;

FIG. 3 illustrates an example block diagram of a user equipment (UE), according to some embodiments;

FIG. 4 illustrates an example block diagram of a BS, according to some embodiments;

FIG. 5 illustrates an example block diagram of cellular communication circuitry, according to some embodiments;

FIG. 6A illustrates an example of connections between an EPC network, an LTE base station (eNB), and a 5G NR base station (gNB), according to some embodiments;

FIG. 6B illustrates an example of a protocol stack for an eNB and a gNB, according to some embodiments;

FIG. 7 illustrates an example of a baseband processor architecture for a UE, according to some embodiments;

FIG. 8 is a communication flow diagram illustrating a method for enhanced resource allocation, according to some embodiments;

FIG. 9 is a flowchart diagram illustrating an example method for computing a resource block bitmap, according to some embodiments;

FIG. 10 is a flowchart diagram illustrating an example method for computing a resource block group or resource block bundle parameters, according to some embodiments;

FIGS. 11A-B are flowchart diagrams illustrating aspects of an example method for computing a type-0 resource allocation, according to some embodiments;

FIGS. 12A-D are flowchart diagrams illustrating aspects of an example method for computing a type-1 resource allocation, according to some embodiments;

FIG. 13 illustrates an example of a resource allocation type-0, according to some embodiments; and

FIG. 14 illustrates an example of a resource allocation type-1, according to some embodiments.

While the features described herein can be susceptible to various modifications and alternative forms, specific embodiments thereof are shown by way of example in the drawings and are herein described in detail. It can be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that can appear throughout the present disclosure are provided below:
3GPP: Third Generation Partnership Project
TS: Technical Specification
RAN: Radio Access Network
RAT: Radio Access Technology
UE: User Equipment
RF: Radio Frequency
BS: Base Station
DL: Downlink
UL: Uplink
LTE: Long Term Evolution
NR: New Radio
5GS: 5G System
5GMM: 5GS Mobility Management
5GC: 5G Core Network
4G: Fourth Generation
5G: Fifth Generation
eNB: Enhanced Node-B
gNB: Next Generation Node-B
IE: Information Element
RRC: Radio Resource Control
MAC: Media Access Control
RLC: Radio Link Control
NAS: Non-Access Stratum
EPS: Evolved Packet System
MM: Mobility Management
SM: Session Management
RB: Resource Block
PRB: Physical Resource Block
VRB: Virtual Resource Block
PDSCH: Physical Downlink Shared Channel
FDRA: Frequency Domain Resource Assignment
TDRA: Time Domain Resource Assignment
BWP: Bandwidth Part
RBG: Resource Block Group
RIV: Resource Indication Value
RBB: Resource Block Bundle
DCI: Downlink Control Information
ALU: Arithmetic Logical Unit
PPA: Performance Power Area

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium can include other types of non-transitory memory as well or combinations thereof. In addition, the memory medium can be located in a first computer system in which the programs are executed, or can be located in a second different computer system which connects to the first computer system over a network, such as the Internet. In the latter instance, the second computer system can provide program instructions to the first computer for execution. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks can range from fine grained (combinatorial logic or look up tables) to coarse grained (arithmetic logic units or processor cores). A programmable hardware element can also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g. smart watch, smart glasses), PDAs, portable Internet devices, music players, data storage devices, other handheld devices, automobiles and/or motor vehicles, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by (or with) a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements can include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It can be noted that since characteristics of the term “channel” can differ according to different wireless protocols, the term “channel” as used herein can be considered as being used in a manner that is consistent with the standard of the type of device with reference to which the term is used. In some standards, channel widths can be variable (e.g., depending on device capability, band conditions, etc.). For example, LTE can support scalable channel bandwidths from 1.4 MHz to 20 MHz. In contrast, WLAN channels can be 22 MHz wide while Bluetooth channels can be 1 MHz wide. Other protocols and standards can include different definitions of channels. Furthermore, some standards can define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure can be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form can be automatically filled out by the computer system where the computer system (e.g., software executing on the computer system) analyzes the fields of the form and fills in the form without any user input specifying the answers to the fields. As indicated above, the user can invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately can refer to a value that is within 1 to 10 percent of the exact (or desired) value. It can be noted, however, that the actual threshold value (or tolerance) can be application dependent. For example, in some embodiments, “approximately” can mean within 0.1% of some specified or desired value, while in various other embodiments, the threshold can be, for example, 2%, 3%, 5%, and so forth, as desired or as required by the particular application.

Concurrent—refers to parallel execution or performance, where tasks, processes, or programs are performed in an at least partially overlapping manner. For example, concurrency can be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions can be interpreted as including the phrase “configured to.” Reciting a component that is configured to perform one or more tasks is expressly intended not to invoke 35 U.S.C. § 112(f) interpretation for that component.

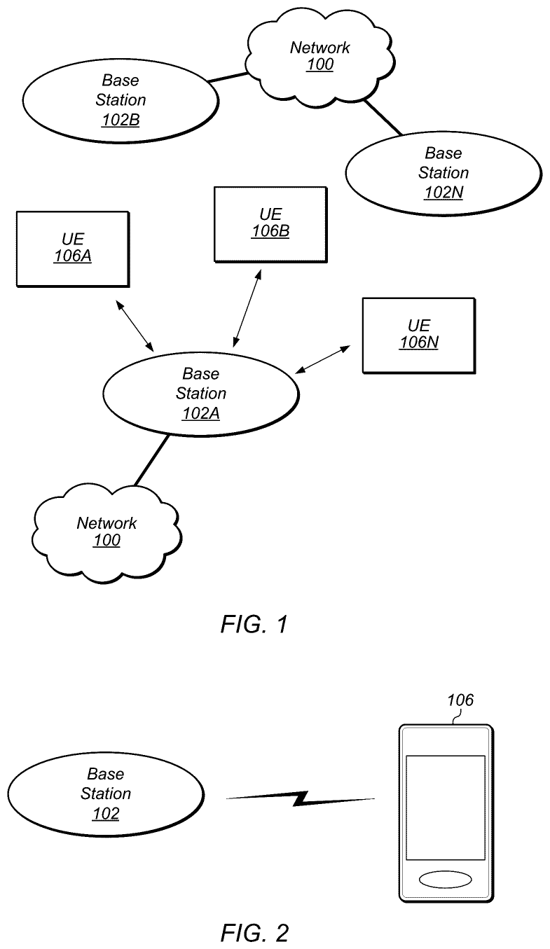

### FIGS. 1 and 2—Communication System

FIG. 1 illustrates a simplified example wireless communication system, according to some embodiments. It is noted that the system of FIG. 1 is merely one example of a possible system, and that features of this disclosure can be implemented in any of various systems, as desired.

As shown, the example wireless communication system includes a base station 102A which communicates over a transmission medium with one or more user devices 106A, 106B, etc., through 106N. Each of the user devices can be referred to herein as a “user equipment” (UE). Thus, the user devices 106 are referred to as UEs or UE devices.

The base station (BS) 102A can be a base transceiver station (BTS) or cell site (a “cellular base station”), and can include hardware that enables wireless communication with the UEs 106A through 106N.

The communication area (or coverage area) of the base station can be referred to as a “cell.” The base station 102A and the UEs 106 can be configured to communicate over the transmission medium using any of various radio access technologies (RATs), also referred to as wireless communication technologies, or telecommunication standards, such as UMTS (associated with, for example, WCDMA or TD-SCDMA air interfaces), LTE, LTE-Advanced (LTE-A), 5G new radio (5G NR), HSPA, ultra-wideband (UWB), etc. Note that if the base station 102A is implemented in the context of LTE, it can alternately be referred to as an ‘eNodeB’ or ‘eNB’. Note that if the base station 102A is implemented in the context of 5G NR, it can alternately be referred to as ‘gNodeB’ or ‘gNB’.

As shown, the base station 102A can also be equipped to communicate with a network 100 (e.g., a core network of a cellular service provider, a telecommunication network such as a public switched telephone network (PSTN), and/or the Internet, among various possibilities). Thus, the base station 102A can facilitate communication between the user devices and/or between the user devices and the network 100. In particular, the cellular base station 102A can provide UEs 106 with various telecommunication capabilities, such as voice, SMS and/or data services.

Base station 102A and other similar base stations (such as base stations 102B . . . 102N) operating according to the same or a different cellular communication standard can thus be provided as a network of cells, which can provide continuous or nearly continuous overlapping service to UEs 106A-N and similar devices over a geographic area via one or more cellular communication standards.

Thus, while base station 102A can act as a “serving cell” for UEs 106A-N as illustrated in FIG. 1, each UE 106 can also be capable of receiving signals from (and possibly within communication range of) one or more other cells (which might be provided by base stations 102B-N and/or any other base stations), which can be referred to as “neighboring cells”. Such cells can also be capable of facilitating communication between user devices and/or between user devices and the network 100. Such cells can include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A can be a next generation base station, e.g., a 5G New Radio (5G NR) base station, or “gNB”. In some embodiments, a gNB can be connected to a legacy evolved packet core (EPC) network and/or to a NR core (NRC) network. In addition, a gNB cell can include one or more transition and reception points (TRPs). In addition, a UE capable of operating according to 5G NR can be connected to one or more TRPs within one or more gNBs.

Note that a UE 106 can be capable of communicating using multiple wireless communication standards. For example, the UE 106 can be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., UMTS (associated with, for example, WCDMA or TD-SCDMA air interfaces), LTE, LTE-A, 5G NR, HSPA, UWB, etc.). The UE 106 can also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 2 illustrates user equipment 106 (e.g., one of the devices 106A through 106N) in communication with a base station 102, according to some embodiments. The UE 106 can be a device with cellular communication capability such as a mobile phone, a hand-held device, a computer or a tablet, or virtually any type of wireless device.

The UE 106 can include a processor that is configured to execute program instructions stored in memory. The UE 106 can perform any of the method embodiments described herein by executing such stored instructions. Alternatively, or in addition, the UE 106 can include a programmable hardware element such as an FPGA (field-programmable gate array) that is configured to perform any of the method embodiments described herein, or any portion of any of the method embodiments described herein.

The UE 106 can include one or more antennas for communicating using one or more wireless communication protocols or technologies. In some embodiments, the UE 106 can be configured to communicate using, for example, LTE using a single shared radio. The shared radio can couple to a single antenna, or can couple to multiple antennas (e.g., for MIMO) for performing wireless communications. In general, a radio can include any combination of a baseband processor, analog RF signal processing circuitry (e.g., including filters, mixers, oscillators, amplifiers, etc.), or digital processing circuitry (e.g., for digital modulation as well as other digital processing). Similarly, the radio can implement one or more receive and transmit chains using the aforementioned hardware. For example, the UE 106 can share one or more parts of a receive and/or transmit chain between multiple wireless communication technologies, such as those discussed above.

In some embodiments, the UE 106 can include separate transmit and/or receive chains (e.g., including separate antennas and other radio components) for each wireless communication protocol with which it is configured to communicate. As a further possibility, the UE 106 can include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTT), and separate radios for communicating using each of Wi-Fi and Bluetooth. Other configurations are also possible.

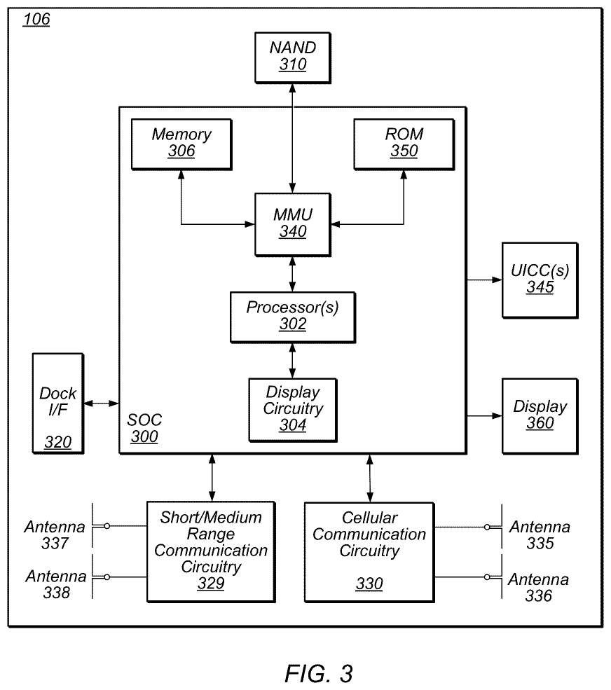

### FIG. 3—Block Diagram of a UE

FIG. 3 illustrates an example simplified block diagram of a communication device 106, according to some embodiments. It is noted that the block diagram of the communication device of FIG. 3 is only one example of a possible communication device. According to embodiments, communication device 106 can be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 can include a set of components 300 configured to perform core functions. For example, this set of components can be implemented as a system on chip (SOC), which can include portions for various purposes. Alternatively, this set of components 300 can be implemented as separate components or groups of components for the various purposes. The set of components 300 can be coupled (e.g., communicatively; directly or indirectly) to various other circuits of the communication device 106.

For example, the communication device 106 can include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which can be integrated with or external to the communication device 106, and cellular communication circuitry 330 such as for 5G NR, LTE, etc., and short to medium range wireless communication circuitry 329 (e.g., Bluetooth™ and WLAN circuitry). In some embodiments, communication device 106 can include wired communication circuitry (not shown), such as a network interface card, e.g., for Ethernet.

The cellular communication circuitry 330 can couple (e.g., communicatively; directly or indirectly) to one or more antennas, such as antennas 335 and 336 as shown. The short to medium range wireless communication circuitry 329 can also couple (e.g., communicatively; directly or indirectly) to one or more antennas, such as antennas 337 and 338 as shown. Alternatively, the short to medium range wireless communication circuitry 329 can couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 can include multiple receive chains and/or multiple transmit chains for receiving and/or transmitting multiple spatial streams, such as in a multiple-input multiple output (MIMO) configuration.

In some embodiments, as further described below, cellular communication circuitry 330 can include dedicated receive chains including and/or coupled to (e.g., communicatively, directly or indirectly) dedicated processors and/or radios for multiple RATs (e.g., a first receive chain for LTE and a second receive chain for 5G NR). In addition, in some embodiments, cellular communication circuitry 330 can include a single transmit chain that can be switched between radios dedicated to specific RATs. For example, a first radio can be dedicated to a first RAT, e.g., LTE, and can be in communication with a dedicated receive chain and a transmit chain shared with an additional radio, e.g., a second radio that can be dedicated to a second RAT, e.g., 5G NR, and can be in communication with a dedicated receive chain and the shared transmit chain.

The communication device 106 can also include and/or be configured for use with one or more user interface elements. The user interface elements can include any of various elements, such as display 360 (which can be a touchscreen display), a keyboard (which can be a discrete keyboard or can be implemented as part of a touchscreen display), a mouse, a microphone and/or speakers, one or more cameras, one or more buttons, and/or any of various other elements capable of providing information to a user and/or receiving or interpreting user input.

The communication device 106 can further include one or more smart cards 345 that include SIM (Subscriber Identity Module) functionality, such as one or more UICC(s) (Universal Integrated Circuit Card(s)) cards 345.

As shown, the SOC 300 can include processor(s) 302, which can execute program instructions for the communication device 106 and display circuitry 304, which can perform graphics processing and provide display signals to the display 360. The processor(s) 302 can also be coupled to memory management unit (MMU) 340, which can be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 329, cellular communication circuitry 330, connector I/F 320, and/or display 360. The MMU 340 can be configured to perform memory protection and page table translation or set up. In some embodiments, the MMU 340 can be included as a portion of the processor(s) 302.

As noted above, the communication device 106 can be configured to communicate using wireless and/or wired communication circuitry. The communication device 106 can be configured to transmit a request to attach to a first network node operating according to the first RAT and transmit an indication that the wireless device is capable of maintaining substantially concurrent connections with the first network node and a second network node that operates according to the second RAT. The wireless device can also be configured to transmit a request to attach to the second network node. The request can include an indication that the wireless device is capable of maintaining substantially concurrent connections with the first and second network nodes. Further, the wireless device can be configured to receive an indication that dual connectivity with the first and second network nodes has been established.

As described herein, the communication device 106 can include hardware and software components for implementing the above features for time division multiplexing DL and UL data for NSA NR operations. The processor 302 of the communication device 106 can be configured to implement part or all of the features described herein, e.g., by executing program instructions stored on a memory medium (e.g., a non-transitory computer-readable memory medium). Alternatively (or in addition), processor 302 can be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 can be configured to implement part or all of the features described herein.

In addition, as described herein, processor 302 can include one or more processing elements. Thus, processor 302 can include one or more integrated circuits (ICs) that are configured to perform the functions of processor 302. In addition, each integrated circuit can include circuitry (e.g., first circuitry, second circuitry, etc.) configured to perform the functions of processor(s) 302.

Further, as described herein, cellular communication circuitry 330 and short range wireless communication circuitry 329 can each include one or more processing elements. For example, one or more processing elements can be included in cellular communication circuitry 330 and, similarly, one or more processing elements can be included in short range wireless communication circuitry 329. Thus, cellular communication circuitry 330 can include one or more integrated circuits (ICs) that are configured to perform the functions of cellular communication circuitry 330. In addition, each integrated circuit can include circuitry (e.g., first circuitry, second circuitry, etc.) configured to perform the functions of cellular communication circuitry 330. Similarly, the short range wireless communication circuitry 329 can include one or more ICs that are configured to perform the functions of short range wireless communication circuitry 329. In addition, each integrated circuit can include circuitry (e.g., first circuitry, second circuitry, etc.) configured to perform the functions of short range wireless communication circuitry 329.

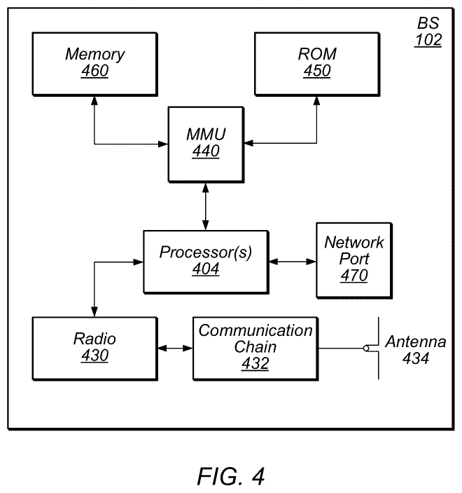

### FIG. 4—Block Diagram of a Base Station

FIG. 4 illustrates an example block diagram of a base station 102, according to some embodiments. It is noted that the base station of FIG. 4 is merely one example of a possible base station. As shown, the base station 102 can include processor(s) 404 which can execute program instructions for the base station 102. The processor(s) 404 can also be coupled to memory management unit (MMU) 440, which can be configured to receive addresses from the processor(s) 404 and translate those addresses to locations in memory (e.g., memory 460 and read only memory (ROM) 450) or to other circuits or devices.

The base station 102 can include at least one network port 470. The network port 470 can be configured to couple to a telephone network and provide a plurality of devices, such as UE devices 106, access to the telephone network as described above in FIGS. 1 and 2.

The network port 470 (or an additional network port) can also or alternatively be configured to couple to a cellular network, e.g., a core network of a cellular service provider. The core network can provide mobility related services and/or other services to a plurality of devices, such as UE devices 106. In some cases, the network port 470 can couple to a telephone network via the core network, and/or the core network can provide a telephone network (e.g., among other UE devices serviced by the cellular service provider).

In some embodiments, base station 102 can be a next generation base station, e.g., a 5G New Radio (5G NR) base station, or “gNB”. In such embodiments, base station 102 can be connected to a legacy evolved packet core (EPC) network and/or to a NR core (NRC) network. In addition, base station 102 can be considered a 5G NR cell and can include one or more transmission and reception points (TRPs). In addition, a UE capable of operating according to 5G NR can be connected to one or more TRPs within one or more gNBs.

The base station 102 can include at least one antenna 434, and possibly multiple antennas. The at least one antenna 434 can be configured to operate as a wireless transceiver and can be further configured to communicate with UE devices 106 via radio 430. The antenna 434 communicates with the radio 430 via communication chain 432. Communication chain 432 can be a receive chain, a transmit chain or both. The radio 430 can be configured to communicate via various wireless communication standards, including, but not limited to, 5G NR, LTE, LTE-A, UMTS, Wi-Fi, UWB, etc.

The base station 102 can be configured to communicate wirelessly using multiple wireless communication standards. In some instances, the base station 102 can include multiple radios, which can enable the base station 102 to communicate according to multiple wireless communication technologies. For example, as one possibility, the base station 102 can include an LTE radio for performing communication according to LTE as well as a 5G NR radio for performing communication according to 5G NR. In such a case, the base station 102 can be capable of operating as both an LTE base station and a 5G NR base station. As another possibility, the base station 102 can include a multi-mode radio which is capable of performing communications according to any of multiple wireless communication technologies (e.g., 5G NR and Wi-Fi, LTE and Wi-Fi, LTE and UMTS, etc.).

As described further subsequently herein, the BS 102 can include hardware and software components for implementing or supporting implementation of features described herein. The processor 404 of the base station 102 can be configured to implement or support implementation of part or all of the methods described herein, e.g., by executing program instructions stored on a memory medium (e.g., a non-transitory computer-readable memory medium). Alternatively, the processor 404 can be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 can be configured to implement or support implementation of part or all of the features described herein.

In addition, as described herein, processor(s) 404 can be comprised of one or more processing elements. For example, one or more processing elements can be included in processor(s) 404. Thus, processor(s) 404 can include one or more integrated circuits (ICs) that are configured to perform the functions of processor(s) 404. In addition, each integrated circuit can include circuitry (e.g., first circuitry, second circuitry, etc.) configured to perform the functions of processor(s) 404.

Further, as described herein, radio 430 can be comprised of one or more processing elements. For example, one or more processing elements can be included in radio 430. Thus, radio 430 can include one or more integrated circuits (ICs) that are configured to perform the functions of radio 430. In addition, each integrated circuit can include circuitry (e.g., first circuitry, second circuitry, etc.) configured to perform the functions of radio 430.

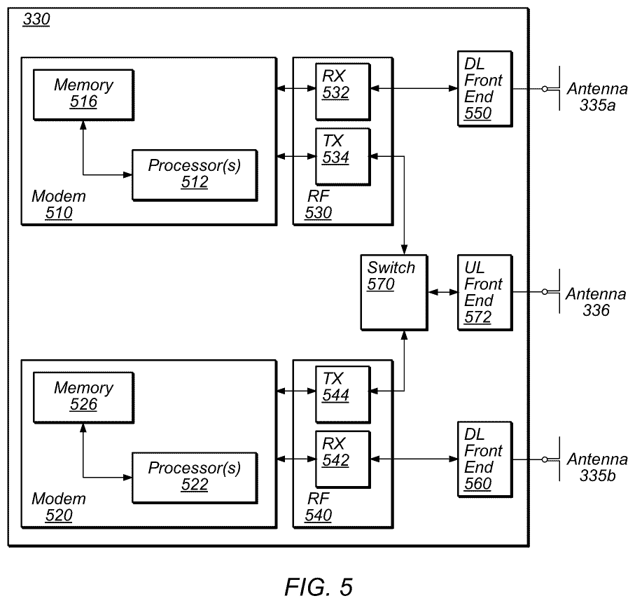

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 330, which can be cellular communication circuitry 430, can be included in a communication device, such as communication device 106 described above. As noted above, communication device 106 can be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 can couple (e.g., communicatively; directly or indirectly) to one or more antennas, such as antennas 335a-b and 336 as shown (in FIG. 5). In some embodiments, cellular communication circuitry 330 can include dedicated receive chains including and/or coupled to (e.g., communicatively, directly or indirectly) dedicated processors and/or radios for multiple RATs (e.g., a first receive chain for LTE and a second receive chain for 5G NR). For example, as shown in FIG. 5, cellular communication circuitry 330 can include a modem 510 and a modem 520. Modem 510 can be configured for communications according to a first RAT, e.g., such as LTE or LTE-A, and modem 520 can be configured for communications according to a second RAT, e.g., such as 5G NR.

As shown, modem 510 can include one or more processors 512 and a memory 516 in communication with processors 512. Modem 510 can be in communication with a radio frequency (RF) front end 530. RF front end 530 can include circuitry for transmitting and receiving radio signals. For example, RF front end 530 can include receive circuitry (RX) 532 and transmit circuitry (TX) 534. In some embodiments, receive circuitry 532 can be in communication with downlink (DL) front end 550, which can include circuitry for receiving radio signals via antenna 335a.

Similarly, modem 520 can include one or more processors 522 and a memory 526 in communication with processors 522. Modem 520 can be in communication with an RF front end 540. RF front end 540 can include circuitry for transmitting and receiving radio signals. For example, RF front end 540 can include receive circuitry 542 and transmit circuitry 544. In some embodiments, receive circuitry 542 can be in communication with DL front end 560, which can include circuitry for receiving radio signals via antenna 335b.

In some embodiments, a switch 570 can couple transmit circuitry 534 to uplink (UL) front end 572. In addition, switch 570 can couple transmit circuitry 544 to UL front end 572. UL front end 572 can include circuitry for transmitting radio signals via antenna 336. Thus, when cellular communication circuitry 330 receives instructions to transmit according to the first RAT (e.g., as supported via modem 510), switch 570 can be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 can be switched to a second state that allows modem 520 to transmit signals according to the second RAT (e.g., via a transmit chain that includes transmit circuitry 544 and UL front end 572).

In some embodiments, the cellular communication circuitry 330 can be configured to perform methods of beam failure recovery based on a unified transmission configuration indicator (TCI) framework, e.g., in 5G NR systems and beyond, as further described herein. For example, TCI frameworks can be characterized by TCI states that are dynamically sent via DCI which can include quasi-colocation (QCL) relationships between downlink reference signals in a channel state information reference signal (CSI-RS) set and physical downlink shared channel (PDSCH) demodulation reference signal (DMRS) ports, according to some embodiments.

As described herein, the modem 510 can include hardware and software components for implementing the above features or for time division multiplexing DL and UL data for NSA NR operations, as well as the various other techniques described herein. The processors 512 can be configured to implement part or all of the features described herein, e.g., by executing program instructions stored on a memory medium (e.g., a non-transitory computer-readable memory medium). Alternatively (or in addition), processor 512 can be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 can be configured to implement part or all of the features described herein.

In addition, as described herein, processors 512 can include one or more processing elements. Thus, processors 512 can include one or more integrated circuits (ICs) that are configured to perform the functions of processors 512. In addition, each integrated circuit can include circuitry (e.g., first circuitry, second circuitry, etc.) configured to perform the functions of processors 512.

As described herein, the modem 520 can include hardware and software components for implementing the above features for communicating a scheduling profile for power savings to a network, as well as the various other techniques described herein. The processors 522 can be configured to implement part or all of the features described herein, e.g., by executing program instructions stored on a memory medium (e.g., a non-transitory computer-readable memory medium). Alternatively (or in addition), processor 522 can be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 can be configured to implement part or all of the features described herein.

In addition, as described herein, processors 522 can include one or more processing elements. Thus, processors 522 can include one or more integrated circuits (ICs) that are configured to perform the functions of processors 522. In addition, each integrated circuit can include circuitry (e.g., first circuitry, second circuitry, etc.) configured to perform the functions of processors 522.

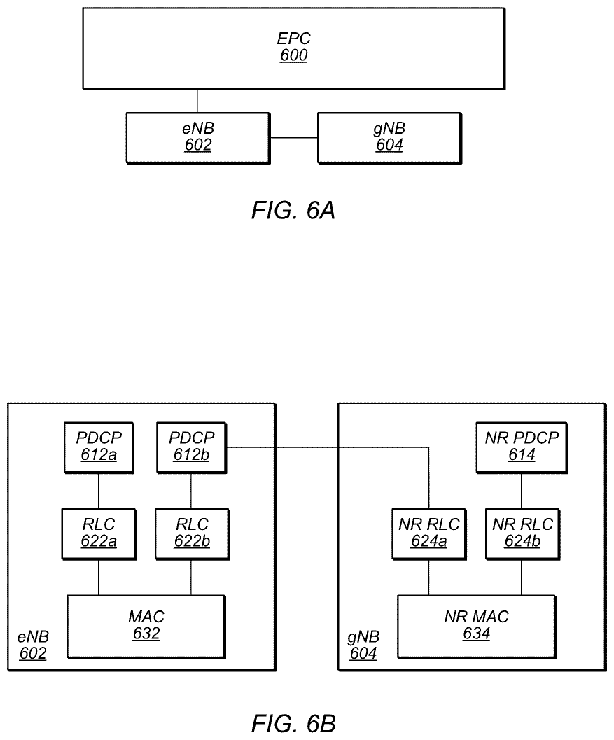

### FIGS. 6A and 6B: 5G NR Architecture with LTE

In some implementations, fifth generation (5G) wireless communication can initially be deployed concurrently with other wireless communication standards (e.g., LTE). For example, dual connectivity between LTE and 5G new radio (5G NR or NR) has been specified as part of the initial deployment of NR. Thus, as illustrated in FIGS. 6A-B, evolved packet core (EPC) network 600 can continue to communicate with current LTE base stations (e.g., eNB 602). In addition, eNB 602 can be in communication with a 5G NR base station (e.g., gNB 604) and can pass data between the EPC network 600 and gNB 604. Thus, EPC network 600 can be used (or reused) and gNB 604 can serve as extra capacity for UEs, e.g., for providing increased downlink throughput to UEs. For example, LTE can be used for control plane signaling and NR can be used for user plane signaling. Thus, LTE can be used to establish connections to the network and NR can be used for data services.

FIG. 6B illustrates a proposed protocol stack for eNB 602 and gNB 604. As shown, eNB 602 can include a medium access control (MAC) layer 632 that interfaces with radio link control (RLC) layers 622a-b. RLC layer 622a can also interface with packet data convergence protocol (PDCP) layer 612a and RLC layer 622b can interface with PDCP layer 612b. Similar to dual connectivity as specified in LTE-Advanced Release 12, PDCP layer 612a can interface via a master cell group (MCG) bearer with EPC network 600 whereas PDCP layer 612b can interface via a split bearer with EPC network 600.

Additionally, as shown, gNB 604 can include a MAC layer 634 that interfaces with RLC layers 624a-b. RLC layer 624a can interface with PDCP layer 612b of eNB 602 via an X2 interface for information exchange and/or coordination (e.g., scheduling of a UE) between eNB 602 and gNB 604. In addition, RLC layer 624b can interface with PDCP layer 614. Similar to dual connectivity as specified in LTE-Advanced Release 12, PDCP layer 614 can interface with EPC network 600 via a secondary cell group (SCG) bearer. Thus, eNB 602 can be considered a master node (MeNB) while gNB 604 can be considered a secondary node (SgNB). In some scenarios, a UE can be required to maintain a connection to both an MeNB and a SgNB. In such scenarios, the MeNB can be used to maintain a radio resource control (RRC) connection to an EPC while the SgNB can be used for capacity (e.g., additional downlink and/or uplink throughput).

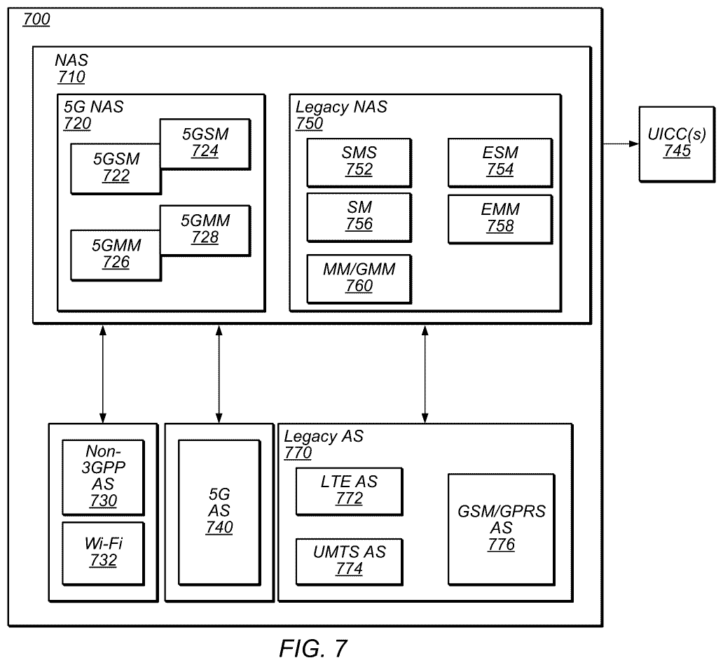

### FIG. 7: UE Baseband Processor Architecture

FIG. 7 illustrates an example of a baseband processor architecture for a UE (e.g., such as UE 106), according to some embodiments. The baseband processor architecture 700 described in FIG. 7 can be implemented on one or more radios (e.g., radios 329 and/or 330 described above) or modems (e.g., modems 510 and/or 520) as described above. As shown, the non-access stratum (NAS) 710 can include a 5G NAS 720 and a legacy NAS 750. The legacy NAS 750 can include a communication connection with a legacy access stratum (AS) 770. The 5G NAS 720 can include communication connections with both a 5G AS 740 and a non-3GPP AS 730 and Wi-Fi AS 732. The 5G NAS 720 can include functional entities associated with both access stratums. Thus, the 5G NAS 720 can include multiple 5G mobility management (MM) entities 726 and 728 and 5G session management (SM) entities 722 and 724. The legacy NAS 750 can include functional entities such as short message service (SMS) entity 752, evolved packet system (EPS) session management (ESM) entity 754, session management (SM) entity 756, EPS mobility management (EMM) entity 758, and mobility management (MM)/GPRS mobility management (GMM) entity 760. In addition, the legacy AS 770 can include functional entities such as LTE AS 772, UMTS AS 774, and/or GSM/GPRS AS 776.

Thus, the baseband processor architecture 700 allows for a common 5G-NAS for both 5G cellular and non-cellular (e.g., non-3GPP access). Note that as shown, the 5G MM can maintain individual connection management and registration management state machines for each connection. Additionally, a device (e.g., UE 106) can register to a single PLMN (e.g., 5G CN) using 5G cellular access as well as non-cellular access. Further, it can be possible for the device to be in a connected state in one access and an idle state in another access and vice versa. Finally, there can be common 5G-MM procedures (e.g., registration, de-registration, identification, authentication, as so forth) for both accesses.

Note that in various embodiments, one or more of the above described functional entities of the 5G NAS and/or 5G AS can be configured to perform methods of enhanced resource allocation, e.g., as further described herein.

### 5G NR Resource Allocation

Enhanced methods for detecting and computing downlink resource blocks for allocated 5G NR physical downlink shared channel (PDSCH) resources in a downlink 5G NR slot in a 5G NR UE can allow for more efficient communications between UEs and the network, according to some embodiments. For example, enhanced methods can be used to more coherently, efficiently and optimally compute allocated resource blocks in a 5G NR UE for allocated 5G NR PDSCH resources in frequency domain resource allocation (FDRA) for both resource allocation type-0 and type-1 schemes respectively as well as for the allocated 5G NR PDSCH symbols in the time domain. Additionally, enhanced methods for computing 5G NR PDSCH physical resource block bitmap and for computing resource block group (RBG) parameters for NR PDSCH resource allocation type-0 and resource block (RB) bundle parameters for NR PDSCH resource allocation type-1 (e.g., interleaved) can be beneficial in efficiently unifying a method of resource allocation for both resource allocation type-0 and type-1 in a 5G NR UE.

For example, in 3GPP release-15 and later, a 5G NR UE can be allocated with NR PDSCH resources carrying user data according to type-0 and type-1 schemes in resource allocation in the frequency domain, according to some embodiments. Furthermore, if the resourceAllocation field in a PDSCH-Config radio resource control (RRC) information element (IE) is set to ‘dynamicswitch’, the FDRA field in the scheduled DCI can be used by a 5G NR UE to determine resource allocation type as either type-0 or type-1, according to some embodiments. Alternatively, the 5G NR UE can derive a resource allocation type for NR PDSCH using the resourceAllocation field in PDSCH-Config RRC IE. For example, if the PDSCH-Config RRC IE is not set to ‘dynamicswitch’, the IE can be set to a value that indicates the resource allocation type as either type-0 or type-1, according to some embodiments.

After determining the type of resource allocation, 5G NR UE can need to compute the allocated physical resource blocks (PRBs) containing the NR PDSCH prior to parameter expansion from parsed DCI, rate-matching (e.g., NR PDSCH resource mapping), demodulation, and decoding of the NR PDSCH, according to some embodiments. Accordingly, a first of the aforementioned enhanced methods can be used to efficiently, optimally and coherently compute an NR PDSCH RB bitmap computation for maxNrofPhysicalResourceBlocks of 275 PRBs. This kernel can be called AK_RB_BITMAP and the maxNrofPhysicalResourceBlocks parameter can be further defined in 3GPP technical specifications, according to some embodiments. Additionally, a second enhanced method can be used to compute RBG parameters for NR PDSCH resource allocation type-0 or RB bundle parameters for NR PDSCH resource allocation type-1 (e.g., interleaved), according to some embodiments. This kernel can be referred to as AK_RBG_RBB, according to some embodiments described herein.

Accordingly, using these two enhanced methods can result in more efficient, optimal, and coherent computing of the frequency domain NR PDSCH resource allocation in PRB order for each of the resource allocation types (e.g., type-0 and type-1). For example, as compared with previous methods which can possibly not have been applicable to both resource allocation types, these enhanced methods can allow for more efficient and flexible resource allocation related computations by using a common framework of methods that can be reused to compute NR PDSCH resource allocation in terms of an RB bitmap in PRB order for both resource allocation type-0 and resource allocation type-1, according to some embodiments.

Without these enhanced methods, the FDRA can have to be implemented separately for each resource allocation type-0 and type-1 and with method flows that can differ from each other and follow directly from 3GPP 5G NR specifications. According to such an approach, the methods can become non-coherent, less-efficient and sub-optimal for a 5G NR UE implementation. Accordingly, the enhanced methods for resource allocation type-0 and type-1 simplify the flow by extracting appropriate parameters to reuse the two methods as needed to compute NR PDSCH resource allocation in terms of an RB bitmap in PRB order, according to some embodiments. These enhanced methods are coherent to both frequency domain resource allocation type-0 and type-1 and therefore the enhanced methods and resource allocation methods can allow for more efficient, optimal, and coherent methods of 5G NR PDSCH resource allocation, according to some embodiments.

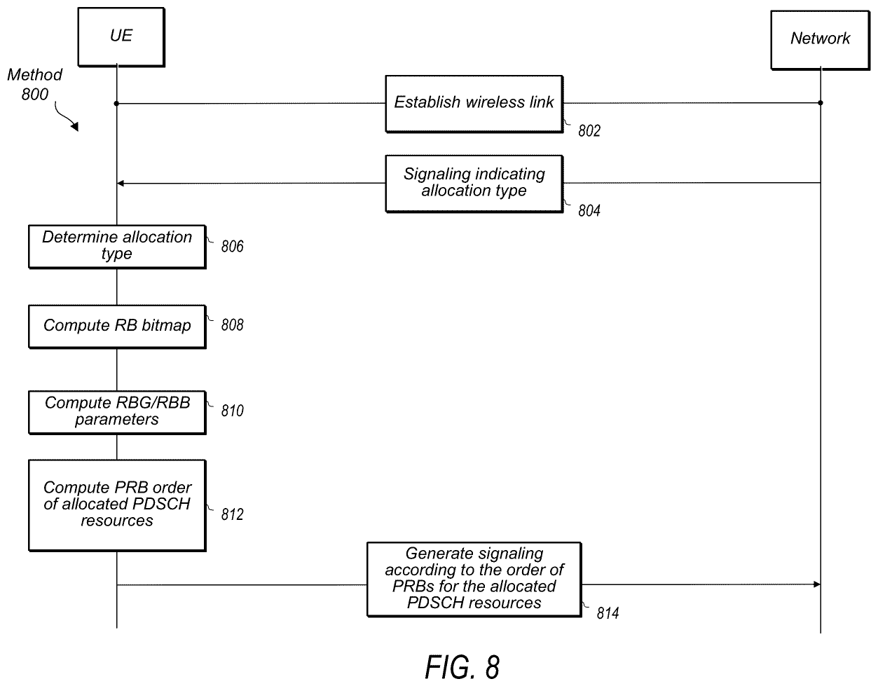

FIG. 8 is a communication flow diagram illustrating an example method (e.g., method 800) for enhanced resource allocation including method elements 802-814, according to some embodiments.

Aspects of the method of FIG. 8 (e.g., method 800) can be implemented by a wireless device, such as the UE(s) 106, in communication with one or more base stations (e.g., BS 102) as illustrated in and described with respect to the Figures, or more generally in conjunction with any of the computer systems or devices shown in the Figures, among other circuitry, systems, devices, elements, or components shown in the Figures, among other devices, as desired. For example, one or more processors (or processing elements) of the UE (e.g., processor(s) 402, baseband processor(s), processor(s) associated with communication circuitry, etc., among various possibilities) can perform some or all of the illustrated method elements or cause the UE to perform some or all of the illustrated method elements. Note that while at least some elements of the method are described in a manner relating to the use of communication techniques and/or features associated with 3GPP specification documents, such description is not intended to be limiting to the disclosure, and aspects of the method can be used in any suitable wireless communication system, as desired. In various embodiments, some of the elements of the methods shown can be performed concurrently, in a different order than shown, can be substituted for by other method elements, or can be omitted. Additional method elements can also be performed as desired. As shown, the method can operate as follows.

At 802, the UE (e.g., a wireless device) can establish a wireless link with cell provided by a cellular base station (e.g., a network node). According to some embodiments, the wireless link can include a cellular link according to 5G NR. For example, the wireless device can establish a session with an AMF entity of the cellular network by way of one or more gNBs that provide radio access to the cellular network. As another possibility, the wireless link can include a cellular link according to LTE. For example, the wireless device can establish a session with a mobility management entity of the cellular network by way of an eNB that provides radio access to the cellular network. Other types of cellular links are also possible, and the cellular network can also or alternatively operate according to another cellular communication technology (e.g., LTE, UMTS, CDMA2000, GSM, etc.), according to various embodiments.

Establishing the wireless link can include establishing a RRC connection with a serving cellular base station, at least according to some embodiments. Establishing the RRC connection can include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device can operate in a RRC connected state. In some instances, the RRC connection can also be released (e.g., after a certain period of inactivity with respect to data communication), in which case the wireless device can operate in a RRC idle state or a RRC inactive state. In some instances, the wireless device can perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

At least according to some embodiments, the wireless device can establish multiple wireless links, e.g., with multiple TRPs of the cellular network, according to a multi-TRP configuration. In such a scenario, the wireless device can be configured (e.g., via RRC signaling) with one or more transmission control indicators (TCIs), e.g., which can correspond to various beams that can be used to communicate with the TRPs. Further, it can be the case that one or more configured TCI states can be activated by media access control (MAC) control element (CE) for the wireless device at a particular time.

At least in some instances, establishing the wireless link(s) can include the wireless device providing capability information for the wireless device. Such capability information can include information relating to any of a variety of types of wireless device capabilities.

At 804, the UE can receive signaling related to an allocation type, according to some embodiments. For example, the UE can receive, from a network node, signaling comprising a field including an indication of a resource allocation type for allocated 5G NR physical downlink shared channel (PDSCH) resources in a downlink (DL) slot. In some embodiments, the signaling can include downlink control information (DCI) or radio resource control (RRC) signaling. According to some embodiments, the field can be a resourceAllocation field in a PDSCH-Config RRC information element (IE).

At 806, the UE can determine a resource allocation type, according to some embodiments. For example, the UE can determine, based on the indication, the resource allocation type as either resource allocation type-0 or resource allocation type-1. According to some embodiments, the UE can determine the resource allocation type based on a value of the field. Furthermore the resourceAllocation field can be set to ‘dynamicswitch’ in which the FDRA field in scheduled DCI can be used by a UE to determine resource allocation type as either type-0 or type-1, according to some embodiments. Alternatively, the resourceAllocation field in the PDSCH-Config RRC IE can be set to a value that indicates the resource allocation type as either type-0 or type-1, according to some embodiments.

At 808, the UE can compute an RB bitmap, according to some embodiments. For example, the UE can perform, using one or more first input parameters, a first computation of a resource block (RB) bitmap for the determined resource allocation type. In some embodiments, the computation can be part of or include using a method to compute the RB bitmap for the determined resource allocation type. Additionally, the first computation can use arithmetic logical unit (ALU) operations including addition, subtraction, bit shift, bitwise AND, bitwise OR, or bitwise NOT operations, according to some embodiments. The aforementioned ALU operations can result in an execution of one cycle per instruction (CPI) making it an optimal choice, according to some embodiments. Furthermore, the first computation can be utilized for multiple iterations to compute and update the RB bitmap for a maximum of 275 PRBs associated with a 32-bit word comprising an array of nine elements. For example, these 32-bit words can be implemented efficiently on a processor or hardware supporting 32-bit architecture. Similar approaches in representing 275 PRBs in units of 16-bit words or 64-bit words can be considered per architectural requirements for which the ideas shared for 32-bit word design in the first computation could be extended accordingly.

According to some embodiments, the first computation can use at least one of parameters rb_bitmap array, rbStartPosition, numRBs, or rbBitMask as part of computing the RB bitmap. For example, one or more first input parameters (e.g., used for the first computation) can include at least of one or more parameters specifying at least one of dimensions or characteristics of an array associated with the RB bitmap, one or more parameters specifying a starting RB for the first computation, one or more parameters specifying a total number of RBs for the first computation, or one or more parameters specifying a mask of RBs associated with the RB bitmap. Additionally, if the number of PRBs exceeds a boundary of the 32-bit word, the first computation can be used to update both lower and upper 32-bit words to compensate for crossover across the word boundary, according to some embodiments. In some embodiments, the RB bitmap can be characterized as an array of nine 32-bit words.

At 810, the UE can compute at least one of resource block group (RBG) or resource block bundle (RBB) parameters, according to some embodiments. For example, the UE can perform, using one or more second input parameters, a second computation of at least one of RBG parameters or RBB parameters for the determined resource allocation type. In some embodiments, the second computation can utilize at least one of a modulo operation, an input nominal size being a power of 2, a ceil of a division operation, or arithmetic logical unit (ALU) operations including addition, subtraction, bit shift and bitwise AND to derive other parameters including a modulo mask and a modulo result, according to some embodiments.

According to some embodiments, the second computation can compute a ceil of a division operation by efficiently using parameters such as modulo mask, modulo result and a logarithm to base-2 operation. Additionally or alternatively, the second computation can utilize a look-up table to implement a logarithm to base-2 operation. Furthermore, the second computation can utilize second input parameters such as one or more parameters specifying a starting RB for the second computation, one or more parameters specifying a size of a bandwidth part (BWP) for the second computation, one or more parameters specifying a size of a RBG for the second computation, or one or more parameters specifying an interleaver size in terms of PRBs for interleaving virtual resource blocks (VRBs) and PRBs for the second computation, according to some embodiments. In some embodiments, the first and second computations can utilize ALU operations for preparation of input parameters and post-processing of output parameters.

At 812, the UE can compute allocated 5G NR PDSCH resources in PRB order, according to some embodiments. For example, the UE can perform, using one or more third input parameters, the RB bitmap, and at least one of the RBG or RBB parameters for the determined resource allocation type, a third computation of an order of physical resource blocks (PRBs) for the allocated 5G NR PDSCH resources. According to some embodiments the third computation can be characterized as a method to compute 5G NR PDSCH resources in PRB order using the RB bitmap and RBG or RBB parameters computed in 808 and 810, respectively.

At 814, the UE can generate signaling according to the computed PDSCH resources, according to some embodiments. For example, the UE can generate signaling for transmission to the 5G NR network node according to the order of PRBs for the allocated 5G NR PDSCH resources. Additionally or alternatively, the UE can generate signaling for transmission to a different network or non-network entity (e.g., another wireless device) according to the order of PRBs for the allocated 5G NR PDSCH resources, according to some embodiments.

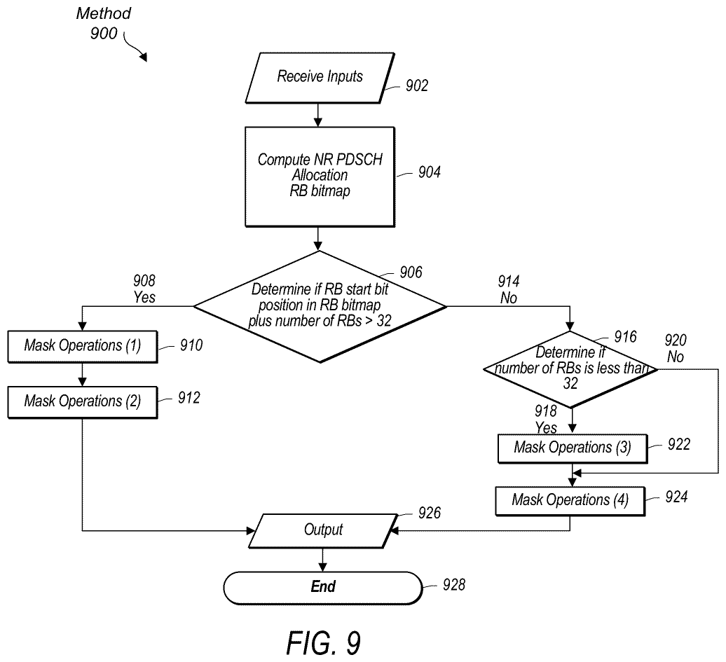

FIG. 9 is a flowchart diagram illustrating an example method including method elements 902-928 for computing a resource block bitmap, according to some embodiments. The method of FIG. 9 (e.g., method 900) may be compatible for both NR PDSCH resource allocation types (e.g., type-0 and type-1), according to some embodiments. For example, as part of the UE computing allocated 5G NR PDSCH resources in PRB order in 812 (e.g., as part of the method 800 of FIG. 8) and for a determined resource allocation type, the method which is type independent (e.g., is compatible with both NR PDSCH resource allocation types (e.g., type-0 and type-1)) can be called for one or more iterations to compute and update an NR PDSCH RB bitmap.

Aspects of the method of FIG. 9 (e.g., method 900) can be implemented by an apparatus of a wireless device, such as the UE(s) 106, in communication with one or more base stations (e.g., BS 102) as illustrated in and described with respect to the Figures, or more generally in conjunction with any of the computer systems or devices shown in the Figures, among other circuitry, systems, devices, elements, or components shown in the Figures, among other devices, as desired. For example, one or more processors (or processing elements) of the UE (e.g., processor(s) 302, baseband processor(s), processor(s) associated with communication circuitry, etc., among various possibilities) may perform the illustrated method elements and/or cause the UE to perform some or all of the illustrated method elements, according to some embodiments. Note that while at least some elements of the method are described in a manner relating to the use of communication techniques and/or features associated with 3GPP specification documents, such description is not intended to be limiting to the disclosure, and aspects of the method can be used in any suitable wireless communication system, as desired. In various embodiments, some of the elements of the methods shown can be performed concurrently, in a different order than shown, can be substituted for by other method elements, or can be omitted. Additional method elements can also be performed as desired. As shown, the method can operate as follows.

At 902, the apparatus can receive one or more input parameters (e.g., inputs), according to some embodiments. An input parameter may define a bitmap array identifier defining an array (e.g., its dimensions and/or other array characteristics) associated with the RB bitmap, according to some embodiments. Additionally or alternatively, an input parameter can specify a mask (e.g., a predefined pattern which can specify areas to edit or use for computations) of RBs associated with the bitmap, specify a starting RB with which to perform the method, and/or specify the total number of RBs to be used in the method of FIG. 9 (e.g., method 900), according to some embodiments.

For example, the method flowchart of FIG. 9 can include utilizing parameters such as a resource block start position (e.g., an RB index whose values can range from 0, . . . , 274), a number of continuous RBs starting from said resource block start position, a bitmask indicating the mask for number of RBs to be updated in the NR PDSCH RB bitmap of 275 PRBs for one iteration of the method of FIG. 9 (e.g., method 900), and/or an input and output RB bitmap array defined for a maximum of 275 PRBs and split into nine 32-bit array elements, according to some embodiments. The representation of the NR PDSCH RB bitmap for a maximum of 275 PRBs can be in terms of a 32-bit array of nine elements. The method of FIG. 9 (e.g., method 900) can include efficiently computing and updating one or two of the 32-bit array elements. Additionally, since the input parameters can be defined for an NR PDSCH RB bitmap of 275 PRBs, it can be possible that the number of RBs can cross the 32-bit word boundary within a 32-bit array element. Hence, a condition to handle crossover across 32-bit word boundary and to update both lower and upper 32-bit words is considered in FIG. 9, according to some embodiments.

At 904, the inputs received at 902 can be used to compute the NR PDSCH allocation resource block bitmap which can be characterized as rb_bitmap[0:8], according to some embodiments. For example, the method can include utilizing the resource block start position to define an index to the 32-bit resource block bitmap array characterized by the formula indexRbBitmap=rbStartPosition>>5, according to some embodiments. Furthermore, the method can also include utilizing the resource block start position to define a bit position of a starting resource block characterized by the formula rbStartBitPositionInRbBitmap=rbStartPosition−(indexRbBitmap<<5), according to some embodiments. Additionally, the method can also include utilizing a resource block bit mask to initialize a mask for all RBs characterized by the formula maskRbBitmap=0xFFFFFFFF, according to some embodiments.

At 906, the method can include determining if a resource block (RB) start bit position in a RB bitmap added to the number of RBs is greater than 32, according to some embodiments. For example, the determination can be characterized by the formula rbStartBitPositionInRbBitmap+numRBs>32, according to some embodiments. At 908, if the determination is true (e.g., yes, rbStartBitPositionInRbBitmap+numRBs is greater than 32), the method can include mask operations (1) at 910. For example, at 910, the method can include updating the mask for enabled RBs characterized by the formula maskRbBitmap=˜((1<<rbStartBitPositionInRbBitmap)−1), according to some embodiments. Furthermore at 910, the method can be used to zero-out bits in the resource block bitmap (e.g., rb_bitmap) for masked bits characterized by the formula rb_bitmap[indexRbBitmap]=rb_bitmap[indexRbBitmap] & (˜maskRbBitmap), according to some embodiments. Moreover, the method can include setting bits in the resource block bitmap for masked bits characterized by the formula rb_bitmap[indexRbBitmap]=rb_bitmap[indexRbBitmap]|(maskRbBitmap & (rbBitMask<<rbStartBitPositionInRbBitmap)), according to some embodiments.

At 912, the method can include performing additional mask operations such as Mask Operations (2), according to some embodiments. For example, at 912, the method can include incrementing an index to point to an upper 32-bit word in the resource block bitmap array since the determination that the resource block start bit position in a resource block bitmap added to the number of resource blocks (e.g., rbStartBitPositionInRbBitmap +numRBs) overflows the 32-bit boundary and is characterized by the formula indexRbBitmap=indexRbBitmap+1, according to some embodiments. Additionally at 912, the method of FIG. 9 (e.g., method 900) can include updating the mask for enabled RBs characterized by the formula maskRbBitmap=(1<<(rbStartBitPositionInRbBitmap+numRBs−2))−1, according to some embodiments. Furthermore at 912, the method can include zeroing-out bits in the resource block bitmap for masked bits characterized by the formula rb_bitmap[indexRbBitmap]=rb_bitmap[indexRbBitmap] & (˜maskRbBitmap), according to some embodiments. Moreover at 912, the method can include setting bits in the resource block bitmap for masked bits characterized by the formula rb_bitmap[indexRbBitmap]=rb_bitmap[indexRbBitmap]|(maskRbBitmap & (rbBitMask>>(32−rbStartBitPositionInRbBitmap)), according to some embodiments. Accordingly, having completed the mask operations of 910 and 912, the method can include generating output parameters at 926.

Alternatively at 914, if the determination of 906 is false (e.g., no, rbStartBitPositionInRbBitmap+numRBs is not greater than 32), the method can include proceeding to 916 and determining whether a number of resource blocks (e.g., numRBs) is less than 32 (e.g., is numRBs<32), according to some embodiments. If the determination of 916 is determined to be true (e.g., yes, numRBs is less than 32), the method can at 918 include proceeding to 922 and performing mask operations (3). For example, at 922, the method can include updating the mask for the number of resource blocks characterized by the formula maskRbBitmap=(1<<numRBs)−1), according to some embodiments.

According to some embodiments, if the determination of 916 is determined to be false (e.g., no, numRBs is not less than 32), the method can at 920 (or after 922) include proceeding to 924 and performing mask operations (4). For example, at 924, the method can include updating the mask from a resource block start bit position in the resource block bitmap to the number of resource blocks which can be characterized by the formula maskRbBitmap=maskRbBitmap<<rbStartBitPositionInRbBitmap according to some embodiments. Furthermore at 924, the method can include zeroing-out bits in the resource block bitmap for masked bits and can be characterized by the formula rb_bitmap[indexRbBitmap]=rb_bitmap[indexRbBitmap] & (˜maskRbBitmap), according to some embodiments. Moreover at 924, the method can include setting bits in the resource block bitmap for masked bits and can be characterized by the formula rb_bitmap[indexRbBitmap]=rb_bitmap[indexRbBitmap]|(maskRbBitmap & (rbBitMask<<rbStartBitPositionInRbBitmap)), according to some embodiments.

Accordingly, having completed mask operations (3) and (4) in 922 and 924 respectively (or alternatively masking procedures (1) and (2) in 910 and 912), the method can include proceeding to 926 and generating output parameters. For example, at 926, the method can include utilizing the previous method elements of 902-924 to produce the NR PDSCH RB allocation resource block bitmap (e.g., rb_bitmap[0:8]) array and further ending the method in 928, according to some embodiments.

In some embodiments, if the NR PDSCH allocation is non-continuous in the frequency domain, then several calls or iterations of the method of FIG. 9 (e.g., method 900) can be needed to compute and update the exact bit positions within the NR PDSCH RB bitmap. Furthermore and according to some embodiments, the NR PDSCH RB bitmap can include a maximum of 275 PRBs. The method elements for computing and updating the bit positions within the NR PDSCH RB bitmap can utilize input parameters which can be further needed for computing the NR PDSCH RB bitmap for one 32-bit word at a time, according to some embodiments.

In some embodiments, the RB bitmap can be characterized as a bitmap containing values of “1” and “0” to indicate an allocation of NR PDSCH in a PRB. This can be defined as an rb_bitmap[] array in the flowcharts of FIGS. 9-12 (which are also related to the method of FIG. 8 (e.g., method 800)), according to some embodiments. In some embodiments, the bitmap can be represented in little-Endian format such that BITO corresponds to PRB0 and BIT274 corresponds to PRB274 since a maximum number of physical resource blocks (PRBs) such as maxNrofPhysicalResourceBlocks can be further defined to be 275 in 5G NR standards. Accordingly, a bit value of 1 can indicate that an NR PDSCH resource is allocated in that PRB and a bit value of 0 can indicate that an NR PDSCH resource is not allocated in that PRB, according to some embodiments.

For efficient implementation, the RB bitmap for a maximum of 275 PRBs can be split into nine 32-bit words, according to some embodiments. These words can be implemented efficiently in a processor or hardware (HW) supporting 32-bit architecture. Similar approaches in representing 275 PRBs in smaller units of 16-bit words or larger units of 64-bit words can be considered per architectural requirements. For example, the ideas presented herein for a 32-bit word design can be extended to 16-bit words or 64-bit words, according to some embodiments.

For a scheduled grant for NR PDSCH, it can be necessary for a 5G NR UE to compute the allocated PRBs of NR PDSCH in frequency domain prior to performing parameter expansion of NR PDSCH related parameters from parsed DCI, rate-matching (e.g., NR PDSCH resource mapping), demodulation, and decoding of NR PDSCH in the physical layer, according to some embodiments. Furthermore, the efficiency and optimality of the method of FIG. 9 (e.g., method 900) can be related to the underlying computation steps that involve arithmetic logic unit (ALU) operations limited to addition, subtraction, bit shift and bitwise AND/OR/NOT operations which take an optimal number of cycles for execution on a processor or HW supporting binary integer arithmetic and logical operations along with a time complexity of O(1), according to some embodiments. In some instances, these ALU operations can result in an execution of one cycle per instruction (CPI) and therefore making it an optimal choice for method of FIG. 9 (e.g., method 900), according to some embodiments. In some embodiments, a time complexity of O(1) can be associated with a method that is not dependent on the input size and therefore the run time can be the same regardless of the input size. Additionally, the input parameters for execution of the method of FIG. 9 (e.g., method 900) can be identified and designed to support both NR PDSCH resource allocation types (e.g., type-0 and type-1) which can result in a coherent, efficient, and optimal method for computing the RB bitmap.

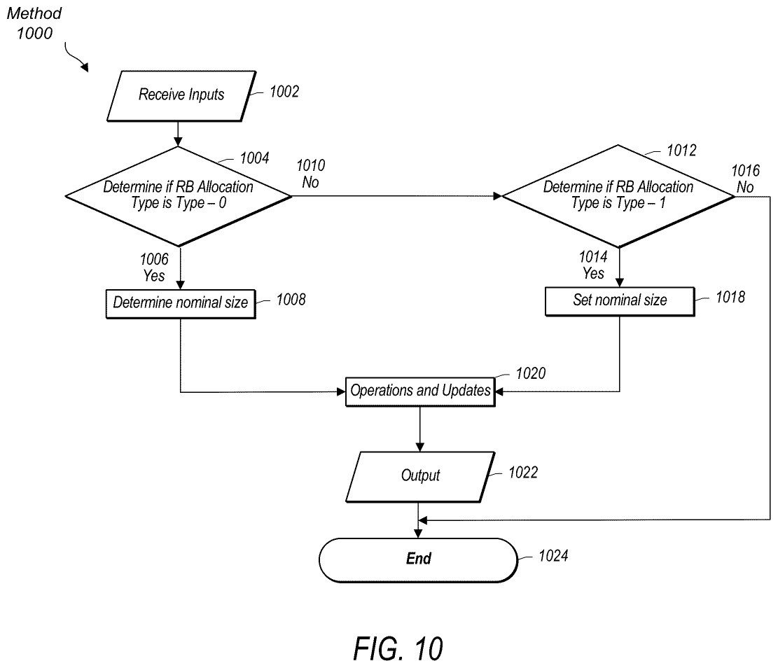

FIG. 10 is a flowchart diagram illustrating an example method (e.g., method 1000) including method elements 1002-1024 for computing a resource block group or resource block bundle parameters, according to some embodiments.

Aspects of the method of FIG. 10 (e.g., method 1000) can be implemented by an apparatus of a wireless device, such as the UE(s) 106, in communication with one or more base stations (e.g., BS 102) as illustrated in and described with respect to the Figures, or more generally in conjunction with any of the computer systems or devices shown in the Figures, among other circuitry, systems, devices, elements, or components shown in the Figures, among other devices, as desired. For example, one or more processors (or processing elements) of the UE (e.g., processor(s) 302, baseband processor(s), processor(s) associated with communication circuitry, etc., among various possibilities) can perform some or all of the illustrated method elements of FIG. 10 or cause the UE to perform some or all of the illustrated method elements. Note that while at least some elements of the method are described in a manner relating to the use of communication techniques and/or features associated with 3GPP specification documents, such description is not intended to be limiting to the disclosure, and aspects of the method can be used in any suitable wireless communication system, as desired. In various embodiments, some of the elements of the methods shown can be performed concurrently, in a different order than shown, can be substituted for by other method elements, or can be omitted. Additional method elements can also be performed as desired. As shown, the method can operate as follows.

At 1002, the method can start and include receiving input parameters (e.g., inputs), according to some embodiments. For example, the inputs can include parameters such as a starting RB of a BWP (e.g., N_BWP_start), a size of a BWP (e.g., N_BWP_size), a resource block group size (e.g., rbg-size), and/or an interleaver size (e.g., vrb-ToPRB-Interleaver), according to some embodiments. For example, N_BWP_start can specify the starting RB (e.g., 5^{th} RB) of the BWP with respect to the starting RB of the common RBs (e.g., RBs 0-31), N_BWP_size can specify the size of the BWP in RBs (e.g., 25RBs), rbg-size can specify the size of the RBG for PDSCH (e.g., config2 which can be associated with specified sizes of the RBGs), and vrb-ToPRB-Interleaver which can indicate an interleaver size in terms of PRBs for interleaving virtual resource blocks (VRBs) and PRBs. These inputs can be obtained via radio resource control (RRC) signaling, according to some embodiments. For example and according to some embodiments, if vrb-ToPRB-Atty. Interleaver is absent in RRC signaling, it can indicate that the VRB to PRB have a one-to-one mapping for both NR PDSCH FDRA type-0 and type-1.

At 1004, the inputs can be used to determine if the RB allocation type (e.g., RB_Allocation_Type) is a Type-0 RB allocation type, according to some embodiments. For example, the method can include utilizing a resource allocation field (e.g., resourceAllocation) from RRC signaling and a Frequency Domain Resource Assignment (FDRA) field in DCI signaling to determine whether or not the allocation type is type-0, according to some embodiments. If the determination at 1004 is that the allocation type is type-0, the method can include proceeding to 1008 and determining or selecting a nominal size parameter (e.g., nominal_size), according to some embodiments. For example, a nominal size “P” can be determined using a lookup table defined in 3GPP standards with table dimensions equal to a resource block group size by a size of a BWP (e.g., rbg-size by N_BWP_size), according to some embodiments. Accordingly, having determined the nominal size “P” for type-0, the method can include proceeding to the operations and updates of 1020.

Alternatively, if the method included determining at 1010 that the allocation type is not type-0, the method can include proceeding to 1012 and determining whether or not the resource allocation type (e.g., RB_Allocation_Type) is a Type-1 resource allocation type, according to some embodiments. If the method included determining that the resource type is Type-1 as in 1014, the method can include setting the nominal size parameter, according to some embodiments. For example, at 1018, the method can include setting a nominal size parameter “L” to an interleaver unit size (e.g., “vrb-ToPRB-Interleaver”) configured in an RRC information element associated with a configuration of a physical downlink shared channel (e.g., a PDSCH-Config RRC IE), according to some embodiments. Accordingly, having set the nominal size parameter “L” to an interleaver unit size, the method can include proceeding to the operations and updates of 1020. Alternatively, if the determination is made that the resource allocation type is neither Type-1 nor Type-0 as in 1016, the method can end at that point.

At 1020, the method can include performing operations and updates using the inputs and determined or set nominal size parameters (e.g., “P” for type-0 or “L” for type-1, according to some embodiments. For example, the method can include performing a modulo operation characterized by the formula moduloMask=(nominal_size−1) and moduloResult=(N_BWP_start & moduloMask). Additionally, at 1020, the method can include defining a ceil (e.g., a ceiling function which can return the smallest integer value that is larger than or equal to a number) of a division operation, according to some embodiments. For example, in order to find a number of RBGs for NR allocation Type-0 or a number of RB bundles for NR allocation type-1 interleaved, the method can utilize the formula N=(N_BWP_size+moduloResult+moduloMask) >>log2 (nominal_size), according to some embodiments. Additionally, at 1020, the method can include updating a resource block group size parameter (e.g., RBG_0_size for NR allocation type-0) or an updated resource block bundle size (e.g., RB_Bundle_0_size for NR allocation type-1 interleaved) using the formula first_size=(nominal_size-moduloResult), according to some embodiments. Furthermore at 1020, the method can include updating a last size of a resource block group (e.g., RBG_last_size) for NR allocation type-0 or updating a last size of a resource block bundle (e.g., RB_Bundle_last_size) for NR allocation type-1 interleaved using the formula last_size=((N_BWP_start+N_BWP_size) & moduloMask), according to some embodiments. Accordingly and having performed the operations and updates at 1020, the method can proceed to 1022 to generate output parameters such as the number of RBGs for NR allocation Type-0 or the number of RB bundles for NR allocation type-1 interleaved, nominal size, first size, and last size (e.g., N, nominal_size, first_size, and last_size) and further ending the method in 1024, according to some embodiments.

According to some embodiments, the method of FIG. 10 (e.g., method 1000) can unify the design for computation of RBG based parameters when NR PDSCH resource allocation type-0 is configured to a 5G NR UE and the computation of RB bundle-based parameters when NR PDSCH resource allocation type-1 with interleaved type is configured to a 5G NR UE, according to some embodiments.

According to some embodiments, the modulo operations described in the method of FIG. 10 (e.g., method 1000) can take into account input nominal size, ‘L’ being a power of 2 number and use ALU operations such as subtraction and bitwise AND to derive the modulo mask and modulo result parameters which can be used further to derive other parameters efficiently in the method. Additionally, to compute a number of RBGs for resource allocation type-0 and a number of RB bundles for resource allocation type-1, 3GPP standards can define a ceil of a division operation and the method can include the use of modulo mask, modulo result and a logarithmic to base-2 operations as indicated in 1020. For example, the logarithm to base-2 operation can be efficiently implemented using ALU operations if the input is a power of 2 number. Furthermore, the computations related to the logarithmic operation of 1020 can include checking or determining if the input number is a power of 2 or not and can further include raising an error (e.g., flag) if the input number is not a power of 2. For example, if the input number is a power of 2, then the following example code block can be used to compute logarithm to base-2:

log2_output = 0
while((input & 0x1) == 0) {
input = input >> 1
log2_output = log2_output + 1
}

Alternatively, a logarithm to base-2 operation can be implemented as a look-up table if all possible input numbers are known. For example, 3GPP standards documents can collectively provide all possible values for the nominal size, ‘L’ mentioned herein. Accordingly, logarithm to base-2 operation can be implemented as a look-up table which can be even more efficient in terms of reducing the number of cycles required to execute the code above with time complexity of O(1), according to some embodiments.

In some embodiments, the bandwidth part (BWP) of FIG. 10 can be either an active bandwidth part or an initial bandwidth part. Furthermore, if the nominal size, ‘L’ for resource allocation type-1 is not configured by the network, then the UE can assume a value as defined in 3GPP technical specification (TS) documents. Additionally, the other inputs such as a resource block group size and an interleaver size (e.g., rbg-size and vrb-ToPRB-Interleaver) can be derived from an RRC information element associated with a configuration of a physical downlink shared channel (e.g., PDSCH-Config RRC IE), according to some embodiments.

According to some embodiments, the method flowchart of FIG. 10 can include the logarithm to base-2 operation to compute some or all of the required parameters using ALU operations limited to addition, subtraction, bit shift and bitwise AND operations. This can utilize an optimal number of cycles for execution (e.g., taking one cycle per instruction (CPI)) on a processor or HW supporting binary integer arithmetic and logical operations along with a time complexity of O(1) which can allow for a coherent and efficient methods of computing resource block group parameters for NR PDSCH resource allocation type-0 and RB bundle parameters for NR PDSCH resource allocation type-1, according to some embodiments. Furthermore, the method of FIG. 10 (e.g., method 1000) can be used to assist in solving the computation of the NR PDSCH RB bitmap for both frequency domain resource allocation types, type-0 and type-1, according to some embodiments.

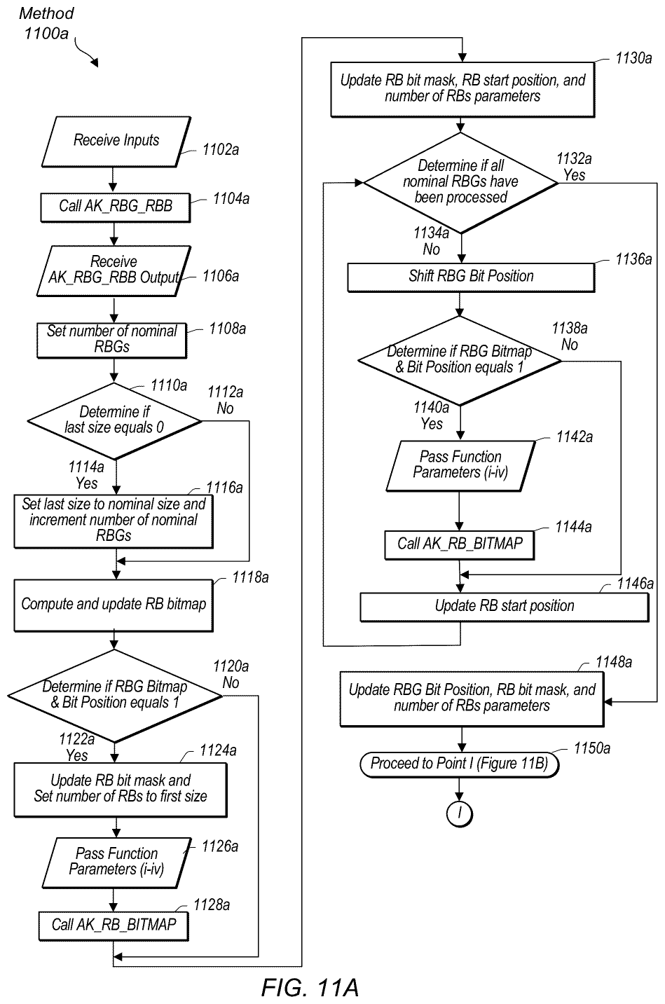

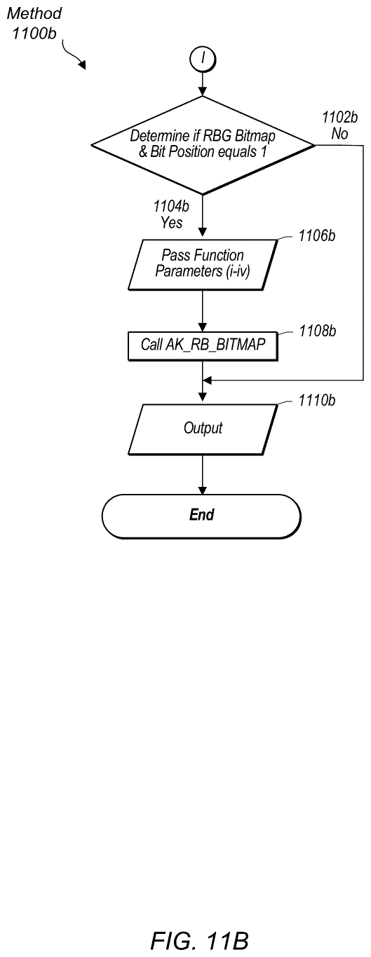

FIGS. 11A-B illustrate aspects of a flowchart diagram for example methods (e.g., methods 1100a and 1100b) including method elements 1102a-1150a and 1102b-1110b for computing for a type-0 resource allocation, according to some embodiments. In some embodiments, FIGS. 11A-B illustrate an example method for calculating an NR PDSCH allocation type-0 RB bitmap using the methods and outputs of FIGS. 9 and 10 respectively, according to some embodiments.

Aspects of the method of FIGS. 11A-B (e.g., methods 1100a and 1100b) can be implemented by an apparatus of a wireless device, such as the UE(s) 106, in communication with one or more base stations (e.g., BS 102) as illustrated in and described with respect to the Figures, or more generally in conjunction with any of the computer systems or devices shown in the Figures, among other circuitry, systems, devices, elements, or components shown in the Figures, among other devices, as desired. For example, one or more processors (or processing elements) of the UE (e.g., processor(s) 302, baseband processor(s), processor(s) associated with communication circuitry, etc., among various possibilities) can perform some or all of the illustrated method elements or cause the UE to perform some or all of the illustrated method elements. Note that while at least some elements of the method are described in a manner relating to the use of communication techniques and/or features associated with 3GPP specification documents, such description is not intended to be limiting to the disclosure, and aspects of the method can be used in any suitable wireless communication system, as desired. In various embodiments, some of the elements of the methods shown can be performed concurrently, in a different order than shown, can be substituted for by other method elements, or can be omitted. Additional method elements can also be performed as desired. As shown, the method can operate as follows.

At 1102a, the method can start and include receiving input parameters, according to some embodiments. For example, input parameters can include a starting RB of a BWP (e.g., N_BWP_start), a size of a BWP (e.g., N_BWP_size), a resource block group size (e.g., rbg-size), and/or a resource block group bitmap (e.g., rbgBitmap), according to some embodiments. Using these input parameters, the method can include proceeding to 1104a and calling (e.g., initiating) the AK_RBG_RBB method associated with FIG. 10, according to some embodiments. Accordingly, the AK_RBG_RBB method can be implemented as described in FIG. 10 resulting in the AK_RBG_RBB outputs which can be received at 1106a. For example, the received output parameters of 1106a can include a number of RBGs for NR allocation Type-0 or a number of RB bundles for NR allocation type-1 interleaved, nominal size, first size, and last size (e.g., N, nominal_size, first_size, and last_size resulting from the operations and updates performed at 1020).

At 1108a, the method can include specifying or setting a number of nominal RBGs parameter with an offset of two (e.g., setting numberOfNominalRBGs=N−2), according to some embodiments. Additionally and at 1110a, the method can include determining whether or not the last size output parameter is equal to zero (e.g., last_size==0), according to some embodiments. For example, the determination of whether the last size output parameter is equal to zero can be made by comparing said output parameter to a value of zero and determining if they are equal. If, at 1114a, it is determined that the last size output parameter is equal to zero, the method can include proceeding to 1116a in which the last size output parameter is set to the nominal size characterized by the formula last_size =nominal_size, according to some embodiments. Furthermore at 1116a, the number of nominal RBGs can be incremented by a value of 1 characterized by the formula numberOfNominalRBGs =numberOfNominalRBGs+1, according to some embodiments. Accordingly, the method can proceed to 1118a. Alternatively at 1112a, if it is determined that the last size output parameter is not equal to zero, the method can proceed directly to 1118a and bypass 1116a.

At 1118a, the method can include computing and updating the resource block bitmap (e.g., rb_bitmap[0:8]), according to some embodiments. For example, at 1118a, a resource block group bit position (e.g., rbgBitPosition) parameter can be updated to a most significant bit (MSB) characterized by the formula rbgBitPosition=(1<<(N−1)), according to some embodiments. Furthermore, at 1118a, a resource block start position (e.g., rbStartPosition) parameter can be initialized such that the resource block start position is equal to a first size subtracted from a nominal size (e.g., rbStartPosition=(nominal_size−first_size)), according to some embodiments. Additionally, at 1118a, a resource block bit mask parameter (e.g., rbBitMask) can be initialized such that rbBitMask =0xFFFFFFFF in order to enable all 32-bits for a single resource block bitmap (e.g., rb_bitmap) word, according to some embodiments.

At 1120a, and if it has been determined that the resource block group bitmap and bit position (e.g., rbgBitmap and rbgBitPosition) are not equal to 1, the method can disregard 1124a-1128a and proceed directly to 1130a. Alternatively, at 1122a, and if it has been determined that the resource block group bitmap and bit position (e.g., rbgBitmap and rbgBitPosition) are equal to 1, the method can include proceeding to 1124a and updating a resource block bit mask parameter (e.g., rbBitMask) characterized by the formula rbBitMask=(1<<first_size)−1. Additionally at 1124a, the number of resource blocks (e.g., numRBs) can be updated or set to the first size characterized by the formula numRBs =first_size, according to some embodiments. At 1126a, the method can include passing or sending function parameters for use according to the method of FIG. 9 (e.g., method 900). For example, at 1126a, the method can include passing a start address for the resource block bitmap (e.g., rb_bitmap) array as well as resource block bit mask, resource block start position, and number of resource blocks parameters (e.g., rbBitMask, rbStartPosition, and numRBs) for use according to the method of FIG. 9 (e.g., method 900), according to some embodiments.

Accordingly, at 1128a, the method can call or initiate the AK_RB_BITMAP method as illustrated by FIG. 9 which can provide an output including a NR PDSCH RB allocation bitmap in an array (e.g., rb_bitmap[0:8] array), according to some embodiments. The method can include proceeding to 1130a and updating parameters including the resource block bit mask, the resource block start position, and the number of resource blocks characterized by the formulas rbBitMask=(1<<nominal_size)−1, rbStartPosition =rbStartPosition+first_size, and numRBs=nominal_size, according to some embodiments.

At 1132a, the method can include determining if all of the nominal RBGs (e.g., numberofNominalRBGs) have been processed, according to some embodiments. If they have all been processed, the method can disregard 1134a-1146a and proceed directly to 1148a. Alternatively, if all of the nominal RBGs have not been processed, at 1136a, the method can include iteratively shifting the resource block group bit position (e.g., rbgBitPosition) to the next bit position after MSB which was updated initially at 1118a characterized by the formula rbgBitPosition=rbgBitPosition>>1, according to some embodiments. At 1138a, the method can include determining if the resource block group bitmap and bit position parameters (e.g., rbgBitmap and rbgBitPosition) are equal to 1, according to some embodiments. If they are not equal to 1, the method can disregard 1140a-1144a and proceed directly to 1146a. Alternatively, at 1140a, if the resource block group bitmap and bit position parameters are equal to 1, the method can pass function parameters (e.g., a start address of a resource block bitmap (e.g., rb_bitmap) array as well as resource block bit mask, resource block start position, and number of RBs parameters (e.g., rbBitMask, rbStartPosition, and numRBs)) to the AK_RB_BITMAP method associated with FIG. 9 at 1142a. Accordingly at 1144a, the method can call or initiate the AK_RB_BITMAP associated with the method detailed in FIG. 9 which can further provide an output including an NR PDSCH RB allocation bitmap in a resource block bitmap (e.g., rb_bitmap[0:8]) array, according to some embodiments.

Furthermore and according to some embodiments, at 1146a the method can update the resource block start position (e.g., rbStartPosition) parameter characterized by the formula rbStartPosition=rbStartPosition+nominal_size and further proceed back to steps 1132a or 1134a depending on the determination of whether all nominal RBGs (e.g., numberOfNominalRBGs) have been processed. Once it has been determined that all Nominal RBGs have been processed at 1132a, at 1148a the method can update the resource block group bit position, the resource block bit mask, and the number of RBs characterized by the formulas rbgBitPosition=rbgBitPosition>>1, rbBitMask=(1 <<last_size)−1, and numRBs=last_size, according to some embodiments. Accordingly and at 1150a, the method can proceed to Point I associated with FIG. 11B, according to some embodiments.

At 1102b, the method can include determining whether or not the resource block group bitmap and bit position (e.g., rbgBitmap and rbgBitPosition) are equal to 1, according to some embodiments. For example, if the resource block group bitmap and bit position are not equal to 1, the method can disregard 1104b-1108b and proceed directly to 1110b. Alternatively, at 1104b, if the resource block group bitmap and bit position are equal to 1, the method can include proceeding to 1106b and passing function parameters (e.g., a start address of rb_bitmap array as well as resource block bit mask rbBitMask, resource block start position rbStartPosition, and number of resource blocks numRBs parameters) to the AK_RB_BITMAP method of FIG. 9 (e.g., method 900). At 1108b, the method can call or initiate the AK_RB_BITMAP associated with the method detailed in FIG. 9 which can further provide an output at 1110b including an NR PDSCH RB allocation bitmap in a resource block bitmap array (e.g., rb_bitmap[0:8] array), according to some embodiments. Accordingly, with the output RB bitmap generated at 1110b, the actual PRB location can be known to specify the order of the PRBs of the allocated 5G NR PDSCH resources and the method for computing a type-0 resource allocation (e.g., NR PDSCH Allocation Type-0) can end, according to some embodiments.

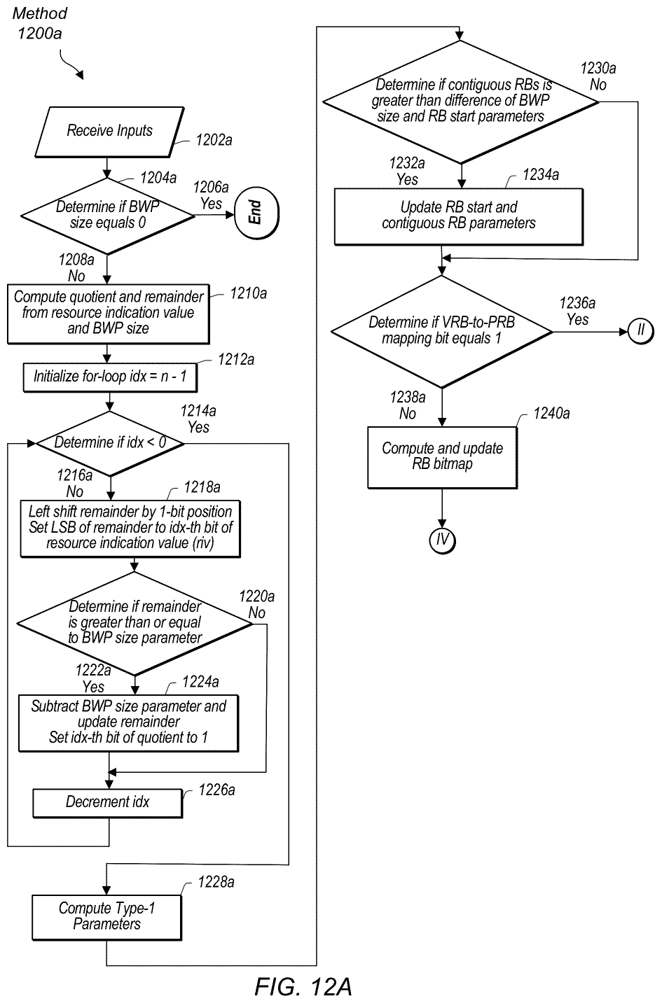

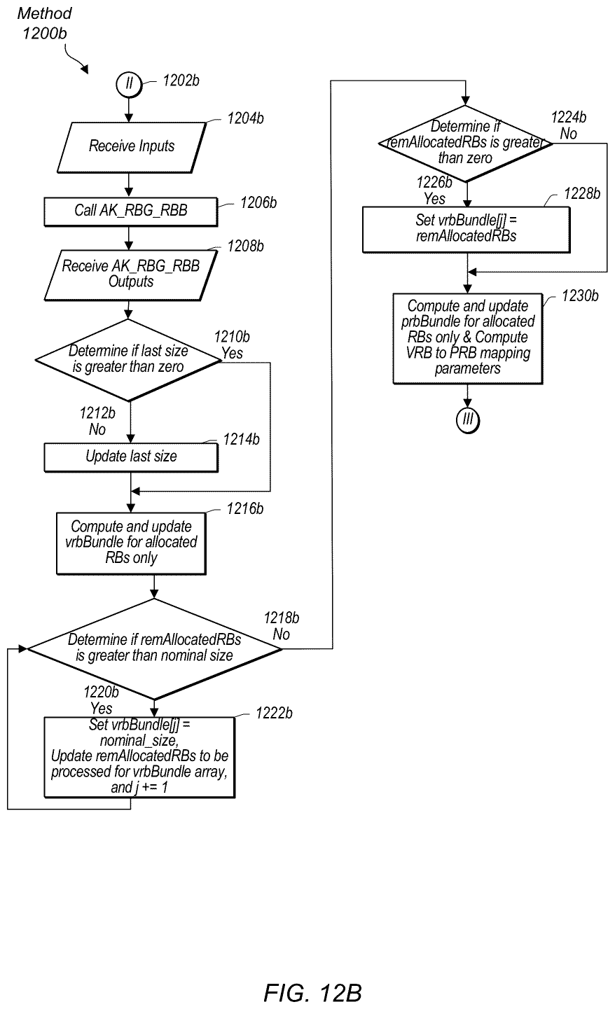

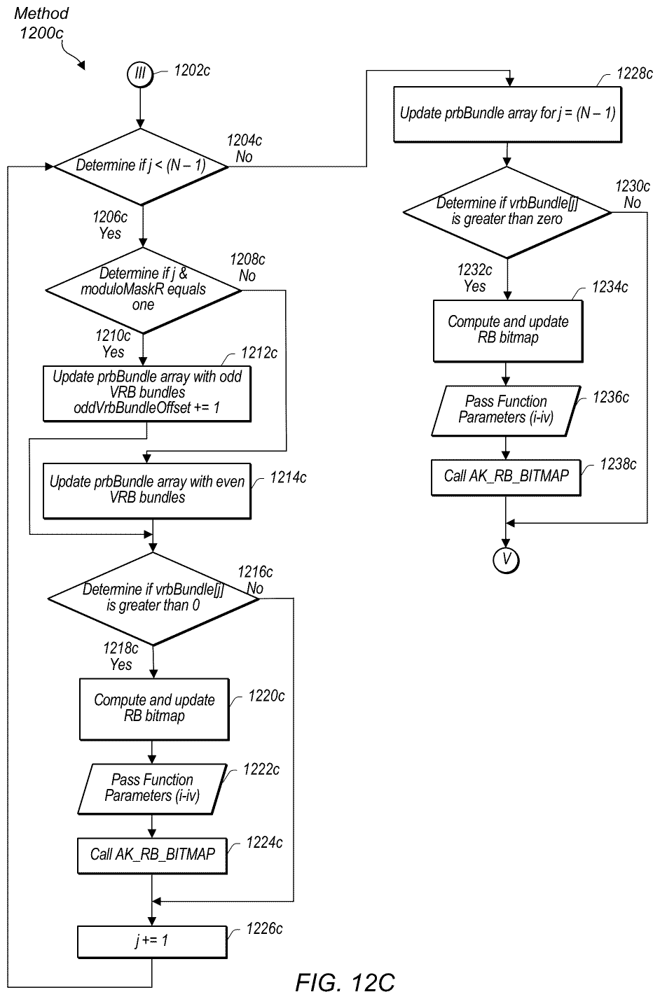

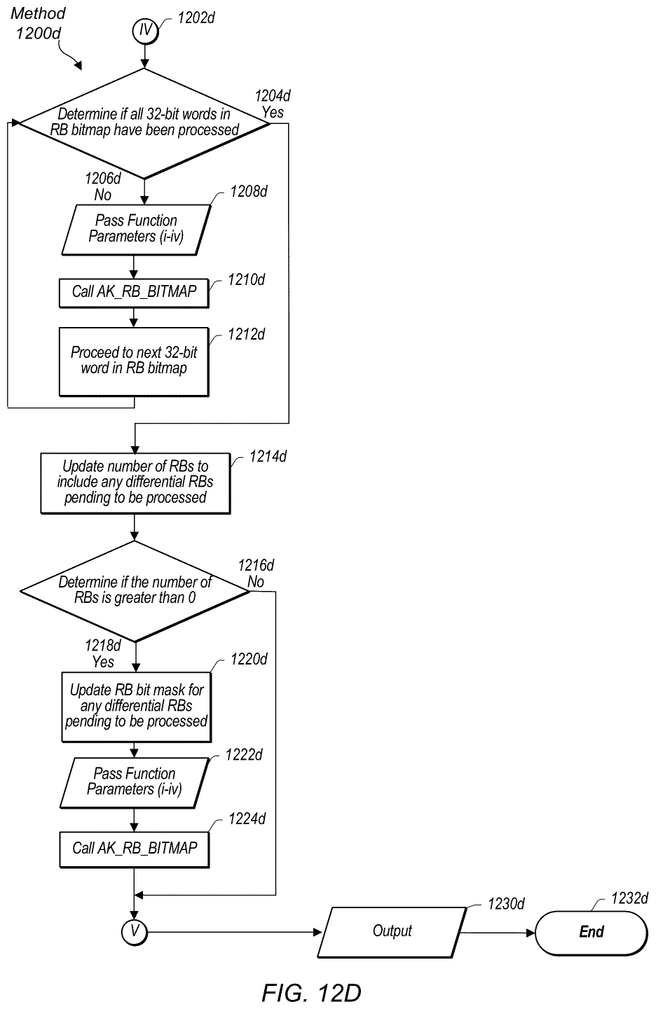

FIGS. 12A-D illustrate aspects of a flowchart diagram for example methods (e.g., methods 1200a, 1200b, 1200c, and 1200d) including method elements 1202a-1240a, 1202b-1230b, 1202c-1238c, and 1202d-1232d for computing ta type-1 resource allocation, according to some embodiments. In some embodiments, FIGS. 12A-D illustrates an example method for calculating an NR PDSCH allocation type-1 RB bitmap using the AK_RB_BITMAP and AK_RBG_RBB methods associated with FIGS. 9 and 10 respectively, according to some embodiments.

Aspects of the method of FIGS. 12A-D (e.g., methods 1200a, 1200b, 1200c, and 1200d) can be implemented by an apparatus of a wireless device, such as the UE(s) 106, in communication with one or more base stations (e.g., BS 102) as illustrated in and described with respect to the Figures, or more generally in conjunction with any of the computer systems or devices shown in the Figures, among other circuitry, systems, devices, elements, or components shown in the Figures, among other devices, as desired. For example, one or more processors (or processing elements) of the UE (e.g., processor(s) 302, baseband processor(s), processor(s) associated with communication circuitry, etc., among various possibilities) can perform some or all of the illustrated method elements or cause the UE to perform some or all of the illustrated method elements. Note that while at least some elements of the method are described in a manner relating to the use of communication techniques and/or features associated with 3GPP specification documents, such description is not intended to be limiting to the disclosure, and aspects of the method can be used in any suitable wireless communication system, as desired. In various embodiments, some of the elements of the methods shown can be performed concurrently, in a different order than shown, can be substituted for by other method elements, or can be omitted. Additional method elements can also be performed as desired. As shown, the method can operate as follows.

At 1202a, the method for calculating an NR PDSCH allocation type-1 RB bitmap can start and can include receiving inputs (e.g., input parameters), according to some embodiments. For example, the inputs received at 1202a can include parameters associated with a resource indication value, a BWP size, an interleaver size and/or a VRB to PRB mapping bit (e.g., riv, N_BWP_size, vrb-ToPRB-Interleaver “L”, VRB-to-PRB mapping), according to some embodiments. According to some embodiments, the “riv” input parameter can be an encoded value containing a starting RB and a length in terms of virtually contiguously allocated RBs. Additionally, the “riv” input parameter can be indicated in the frequency domain resource assignment (FDRA) field via DCI signaling for allocation type-1, according to some embodiments. Accordingly, the method can include proceeding to 1204a and determining whether the BWP size parameter (e.g., N_BWP_size) is equal to zero, according to some embodiments. For example, if the BWP size parameter is equal to zero, at 1206a, the method can end. Alternatively and at 1208a, if the BWP size parameter is determined to be not equal to zero, the method can include proceeding to 1210a and using the inputs of 1202a, to start computing a quotient and a remainder from resource indication value (riv) parameter and BWP size parameter (e.g., riv/N_BWP_size) and further initializing the quotient and remainder of the computation to zero, according to some embodiments.

At 1212a, the method can include initializing a for-loop characterized by the formula idx=n−1, according to some embodiments. In some embodiments, “n” can be a 32-bit word-size in the resource indication value (riv). The method can then include determining whether idx is less than zero, according to some embodiments. For example, if idx is determined to be less than zero at 1214a, the method can disregard 1216a-1226a and proceed directly to 1228a, according to some embodiments. Alternatively, if idx is determined to not be less than zero as in 1216a, the method can include proceeding to 1218a and shifting the remainder value by 1-bit position to the left, according to some embodiments. Additionally at 1218a, the method can include setting a least significant bit (LSB) of the remainder to the idx-th bit of riv. For example, the LSB of the remainder can be associated with a bit of riv which corresponds to the current iteration instance of the for-loop from 1212a.

The method can then include determining whether the remainder is greater than or equal to the BWP size parameter (e.g., N_BWP_size), according to some embodiments. For example, if the remainder is determined to not be greater than or equal to N_BWP_size as in 1220a, the method can disregard 1222a-1224a and proceed directly to 1226a, according to some embodiments. Alternatively, if the remainder is determined to be greater than or equal to N_BWP_size as in 1222a, the method can include proceeding to 1224a and subtracting N_BWP_size from the remainder and updating the remainder, according to some embodiments. Additionally at 1224a, the method can include setting the idx-th bit of the quotient to a value of 1. At 1226a, the method can include decrementing idx and proceeding back to the determination of whether idx is less than zero, according to some embodiments.

Once idx has been determined to be less than zero as in 1214a, the method can include computing type-1 parameters at 1228a. At 1228a, the method can include computing NR PDSCH FDRA Type-1 parameters characterized by the formula RB_start =remainder and L_RBs=quotient+1, according to some embodiments. The method can then proceed to determine if the contiguously allocated resource blocks (e.g., L_RBs) is greater than the difference between the BWP size parameter and the starting resource block (e.g., N_BWP_size−RB_start), according to some embodiments. For example, if L_RBs is not greater than (N_BWP_size−RB_start) as in 1230a, the method can disregard and proceed past 1232a and 1234a. Alternatively, if L_RBs is greater than (N_BWP_size−RB_start) as in 1232a, the method can include updating or setting RB_start equal to N_BWP_size−1−RB_start and further updating or setting the contiguously allocated RBs (e.g., L_RBs) equal to N_BWP_size+2−L_RBs, according to some embodiments.

The method can then proceed to determine if a mapping bit (e.g., the VRB-to-PRB mapping bit) is equal to 1, according to some embodiments. For example, if the VRB-to-PRB mapping bit is determined to be equal to 1 (e.g., meaning interleaving is enabled for type-1) as in 1236a, the method can proceed to Point II of FIG. 12B. Alternatively, if the VRB-to-PRB mapping bit is determined to not be equal to 1 as in 1238a, the method can include proceeding to 1240a and computing and updating the resource block bitmap array (e.g., rb_bitmap[0:8]), according to some embodiments. For example and at 1240a, the numberOf32BitRbBitmaps parameter can be set equal to L_RBs>>5, according to some embodiments. Furthermore, at 1240a, a resource block bit mask parameter (e.g., rbBitMask) can be initialized such that rbBitMask=0xFFFFFFFF to enable all 32-bits for a single resource block bitmap (e.g., rb_bitmap) word, according to some embodiments. Furthermore, a resource block start position (e.g., rbStartPosition) parameter can be initialized according to the formula rbStartPosition=RB_start, and the number of resource blocks (e.g., numRBs) parameter can be initialized such that numRBs=32, according to some embodiments. After performing said computations and updating the resource block bitmap (e.g., rb_bitmap[0:8]), the method can proceed to Point IV of FIG. 12D.

At 1202b and having determined that the VRB-to-PRB mapping bit to be equal to 1 as in 1236a, the method can proceed to 1204b of FIG. 12B. For example and at 1204b, the method can include receiving input parameters associated with interleaver size and/or BWP start and size parameters (e.g., vrb-ToPRB-Interleaver “L”, N_BWP_start, and/or N_BWP_size), according to some embodiments. Using these input parameters, the method can include proceeding to 1206b and calling (e.g., initiating or implementing) the AK_RBG_RBB method related to FIG. 10, according to some embodiments. Accordingly, the AK_RBG_RBB method can be implemented as described in FIG. 10 resulting in the AK_RBG_RBB outputs which can be received at 1208b. For example, the output parameters of 1208b can include N, nominal_size, first_size, and last_size (e.g., resulting from the operations and updates performed at 1020), according to some embodiments.

According to some embodiments, the method can include determining if a last size parameter of the resource block bundle (e.g., last_size) is greater than zero. For example, if last_size is determined to be greater than zero as in 1210b, the method can disregard 1212b and 1214b and proceed directly to 1216b, according to some embodiments. Alternatively, if last_size is determined to not be greater than zero as in 1212b, the method can include proceeding to 1214b and setting last_size to nominal_size, according to some embodiments.

The method can then proceed to 1216b to compute and update a VRB bundle array (e.g., vrbBundle[0:N−1]) for allocated RBs only, according to some embodiments. At 1216b, the method can include initializing the vrbBundle array containing allocated RBs to zero. Additionally at 1216b, the method can include initializing the vrbBundle StartRbOffset array to store a start RB offset value for each of the VRB bundles, according to some embodiments. Furthermore at 1216b, the method can include finding a start of VRB allocation accounting N_BWP_start and RB_start offsets and using moduloMask and moduloResult from the AK_RBG_RBB method of FIG. 10 (e.g., method 1000), according to some embodiments. Additionally at 1216b, the method can use a logarithm to base-2 procedure (as previously described) to find a first VRB bundle index ‘j’ that holds valid allocated RBs, according to some embodiments. Furthermore at 1216b, the method can include finding a number of allocated RBs in the first VRB bundle index and update the start RB position for the first VRB bundle. Additionally, the method can use a minimum of numRBs and L_RBs (e.g., min (numRBs and L_RBs)) to update the start RB offset for the first VRB bundle containing allocated RBs. Furthermore at 1216b, the method can include updating remAllocatedRBs to be processed for updating the vrbBundle array, according to some embodiments. Additionally at 1216b, the method can include incrementing the value of ‘j’ such that j+=1 (e.g., j=j+1), according to some embodiments.

After computing and updating vrbBundle[0:N−1] for allocated RBs only, the method can include determining if the number of remaining allocated RBs parameter (e.g., remAllocatedRBs) is greater than a nominal size parameter (e.g., nominal_size), according to some embodiments. If it is determined that if remAllocatedRBs is not greater than nominal_size as in 1218b, the method can disregard 1220b-1222b and proceed to either 1224b or 1226b. Alternatively, if remAllocatedRBs is determined to be greater than nominal_size as in 1220b, the method can include proceeding to 1222b and setting vrbBundle[j] equal to nominal_size and updating remAllocatedRBs to be processed for the vrbBundle array. Additionally at 1222b, the method can include incrementing the value of ‘j’ such that j+=1 (e.g., j=j+1), according to some embodiments. Following 1222b, the method can proceed back to determining if remAllocatedRBs is greater than the nominal_size parameter, according to some embodiments.

In some embodiments the method can include determining if the number of remaining allocated RBs parameter (e.g., remAllocatedRBs) is greater than zero, according to some embodiments. For example, if it is determined that if remAllocatedRBs is not greater than zero as in 1224b, the method can disregard 1226b-1228b and proceed directly to 1230b. Alternatively, if remAllocatedRBs is determined to be greater than zero as in 1226b, the method can include proceeding to 1228b and setting or updating vrbBundle[j] equal to remAllocatedRBs. Accordingly, after 1228b or 1224b (e.g., depending on whether or not remAllocatedRBs is greater than zero), the method can include proceeding to 1230b and computing and updating a PRB bundle array (e.g., prbBundle[0:N−1]) for allocated RBs only in addition to computing VRB to PRB mapping parameters. At 1230b, the method can include initializing a prbBundle array containing allocated RBs to zero, according to some embodiments. Furthermore at 1230b, the method can include initializing parameters such as R, moduloMaskR, C, rbStartPosition, and oddVrbBundleOffset, according to some embodiments. Additionally at 1230b, the method can include initializing VRB bundle index ‘j’ and PRB bundle index ‘f_j’ which can be defined according to 3GPP standards, according to some embodiments. After 1230b, the method can proceed to Point III of FIG. 12C.

The method associated with FIGS. 12A-B can continue at Point III of FIG. 12C associated with 1202c and further include initiating a while-loop characterized by j<(N−1), according to some embodiments. For example, if j<(N−1) is determined to not be true as in 1204c, the method can disregard 1206c-1226c and proceed directly to 1228c. Alternatively, if j<(N−1) is determined to be true as in 1206c, the method can include determining if the parameter(s) (j & moduloMaskR) are equal to 1. For example, if the parameter(s) (j & moduloMaskR) are not equal to 1 as in 1208c, the method can disregard 1210c-1212c and proceed directly to 1214c. Alternatively, if the parameter(s) (j & moduloMaskR) are equal to 1 as 1210c, the method can include proceeding to 1212c and update the prbBundle array with odd VRB bundles and incrementing the parameter oddVrbBundleOffset by a value of 1 characterized by the formula oddVrbBundleOffset+=1 (e.g., oddVrbBundleOffset=oddVrbBundleOffset+1), according to some embodiments. According to some embodiments, 1212c can be followed by 1216c or 1218c associated with determining whether the VRB bundle at index ‘j’ (e.g., vrbBundle[j]) is greater than zero. Alternatively, having determined that (j & moduloMaskR) are not equal to 1 as in 1208c, the method at 1214c can include updating the prbBundle array with even VRB bundles, according to some embodiments.

The method can include determining whether or not vrbBundle[j] is greater than zero, according to some embodiments. For example, if vrbBundle[j] is not greater than zero as in 1216c, the method can disregard 1218c-1224c and proceed directly to 1226c, according to some embodiments. Alternatively, if vrbBundle[j] is greater than zero as in 1218c, the method can include proceeding to 1220c and computing and updating the resource block bitmap (e.g., rb_bitmap[0:8]). For example and at 1220c, the method can include setting the number of RBs parameter (e.g., numRBs) equal to vrbBundle[j], setting the resource block bit mask parameter (e.g., rbBitMask) equal to (1<<numRBs)−1, and setting the resource block start position (e.g., rbStartPosition) equal to (f_j*nominal_size) −(first_size & moduloMask)+vrbBundleStartRbOffset[j], according to some embodiments.

At 1222c, the method can include passing function parameters (e.g., a start address of a resource block bitmap (e.g., rb_bitmap) array as well as resource block bit mask, resource block start position, and number of resource blocks parameters (e.g., rbBitMask, rbStartPosition, and numRBs)) to the AK_RB_BITMAP method of FIG. 9 (e.g., method 900). Accordingly at 1224c, the method can include calling or initiating the AK_RB_BITMAP method detailed in FIG. 9 which can further provide an output including an NR PDSCH RB allocation bitmap in a resource block bitmap array (e.g., rb_bitmap[0:8] array), according to some embodiments. At 1226c, the method can include incrementing the value of ‘j’ such that j+=1 (e.g., j=j+1) and proceeding back to the start of the while-loop (e.g., at 1204c or 1206c depending on whether or not j<(N−1)), according to some embodiments.

At 1228c, the method can include updating the prbBundle array for j=(N−1), according to some embodiments. Furthermore, the method can include determining whether or not the VRB bundle at index ‘j’ (e.g., vrbBundle[j]) is greater than zero, according to some embodiments. For example, if vrbBundle[j] is not greater than zero as in 1230c, the method can disregard 1232c-1238c and proceed directly to Point V of FIG. 12D, according to some embodiments. Alternatively, if vrbBundle[j] is determined to be greater than zero as in 1232c, the method can proceed to 1234c to compute and update resource block bitmap array (e.g, rb_bitmap[0:8]). For example, the method can include updating or setting parameters such as numRBs equal to vrbBundle[j], setting rbBitMask equal to (1<<numRBs)−1, and/or setting rbStartPosition equal to (f_j*nominal_size)−(first_size & moduloMask)+vrbBundleStartRbOffset[j], according to some embodiments.

At 1236c, the method can include passing function parameters (e.g., a start address of the resource block bitmap array (e.g., rb_bitmap array) as well as resource block bit mask, resource block start position, and number of resource blocks parameters (e.g., rbBitMask, rbStartPosition, and numRBs)) to the AK_RB_BITMAP method of FIG. 9 (e.g., method 900). Accordingly at 1238c, the method can include calling or initiating the AK_RB_BITMAP method detailed in FIG. 9 which can further provide an output including an NR PDSCH RB allocation bitmap in a resource block bitmap array (e.g., rb_bitmap[0:8]), according to some embodiments. After 1238c, the method can proceed to Point V of FIG. 12D, according to some embodiments.

Proceeding from Point IV of FIG. 12D, the method can include determining if all the applicable 32-bit words in the resource block bitmap array (e.g., numberOf32BitRbBitmaps) have been processed at 1202d. For example, if all the applicable 32-bit words in the RB bitmap array have been processed as in 1204d, the method can disregard 1206d to 1212d and proceed directly to 1214d, according to some embodiments. Alternatively, if all the applicable 32-bit words in the RB bitmap array have not been processed as in 1206d, the method can proceed to 1208d in which function parameters (e.g., a start address of the RB bitmap (rb_bitmap) array as well as resource block bit mask, resource block start position, and number of resource blocks parameters (e.g., rbBitMask, rbStartPosition, and numRBs)) are passed to the AK_RB_BITMAP method of FIG. 9 (e.g., method 900). Accordingly at 1210d, the method can include calling or initiating the AK_RB_BITMAP method detailed in FIG. 9 which can further provide an output including an NR PDSCH RB allocation bitmap in a resource block bitmap array (e.g., rb_bitmap[0:8]), according to some embodiments. At 1212d, the method can include starting from (or proceeding to) the next 32-bit word in the resource block bitmap array (e.g., rb_bitmap[0:8]) characterized by the formula rbStartPosition=rbStartPosition+32, according to some embodiments. Accordingly, the method can proceed back to either 1204d or 1206d depending on whether or not all of the 32-bit words of the RB bitmap array have been processed, according to some embodiments.

At 1214d, the method can include updating the number of resource blocks (e.g., numRBs) to include any differential RBs pending to be processed. Furthermore, the method can proceed to determine if the number of resource blocks is greater than 0, according to some embodiments. For example, if the number of resource blocks is not greater than 0 as in 1216d, the method can disregard 1218d-1224d and proceed directly to Point V of FIG. 12D. Alternatively, if the number of resource blocks is determined to be greater than 0 as in 1218d, the method can proceed to 1220d in which rbBitMask is updated for any differential RBs pending to be processed characterized by the formula rbBitMask =(1<<numRBs)−1, according to some embodiments.

At 1222d, the method can include passing function parameters (e.g., a start address of the resource block bitmap (e.g., rb_bitmap array) as well as resource block bit mask, resource block start position, and number of resource blocks parameters (e.g., rbBitMask, rbStartPosition, and numRBs)) to the AK_RB_BITMAP method of FIG. 9 (e.g., method 900). Accordingly at 1224d, the method can include calling or initiating the AK_RB_BITMAP method detailed in FIG. 9 which can further provide an output including an NR PDSCH RB allocation bitmap in a resource block bitmap (e.g., rb_bitmap[0:8]) array, according to some embodiments. After 1224d, the method can proceed to Point V of FIG. 12D and further to 1230d which can provide an output of an NR PDSCH Allocation Type-1 RB bitmap in the resource block bitmap such as rb_bitmap[0:8], according to some embodiments. Accordingly, with the output RB bitmap generated at 1230d, PRB bundle allocation in terms of VRB bundles can be known to specify the order of the PRBs of the allocated 5G NR PDSCH resources and the method for computing a type-1 resource allocation (e.g., NR PDSCH Allocation Type-1) can end at 1232d, according to some embodiments.

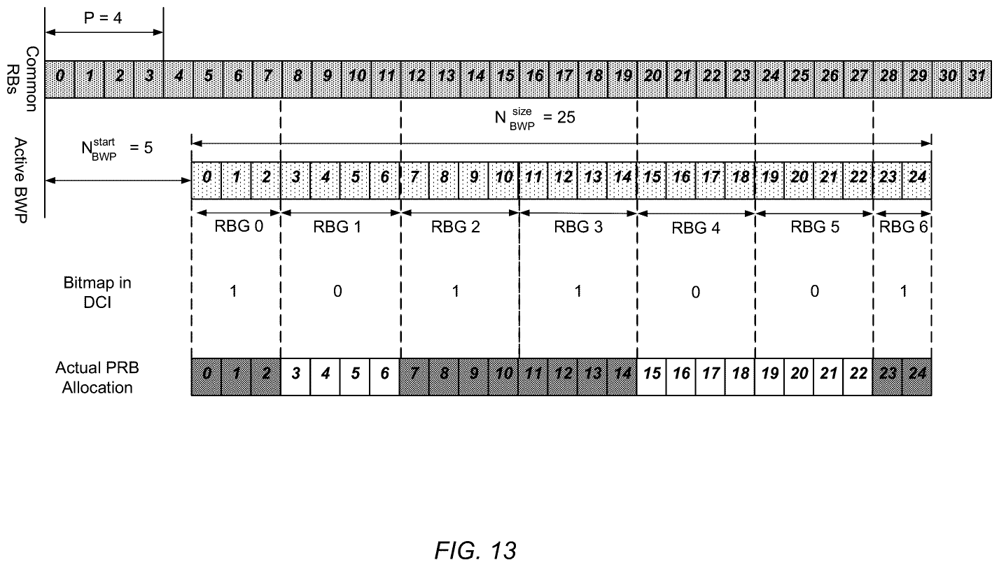

FIG. 13 illustrates an example of resource allocation type-0, according to some embodiments. In some embodiments, FIG. 13 illustrates an example of NR PDSCH FDRA Type-0 and actual PRB allocation, for example based on the method illustrated in FIG. 11 (e.g., method 1100) which can compute allocated 5G NR PDSCH resources in PRB order, according to some embodiments. For example, common RBs can span from 0 to 31 RBs and “P” can correspond to a nominal size for type-0 (e.g., nominal size “P”). Furthermore, an active bandwidth part (BWP) for the user can correspond to VRBs 0 to 24 associated with a N_BWP_size of 25 (e.g., N_BWP_size=25) and the starting VRB of the BWP can be VRB 5 with respect to the starting RB of the common RBs (e.g., N_BWP_start =5), according to some embodiments.

According to some embodiments, the nominal RBG size for a particular configuration (e.g., config2 as one example) can be 4 RBs (e.g., P=4 RBs). Additionally, the parameter rbg-size can be configured as or set to “config2” such that the number of RBGs=7, RBG-first size=3 RBs, RBG-last size=2 RBs and remaining RBG sizes=4 RBs. For example, “config2” can be associated with 7 RBGs in which the first RBG is 3 VRBs in size, the last is 2 VRBs in size, and the other RBGs are 4 VRBs in size, according to some embodiments.

Accordingly, the RBGs can include RBG 0 corresponding to VRBs 0, 1, and 2 of the active BWP, a bitmap value of “1” in DCI, and PRBs 0, 1 and 2 in which the VRBs of RBG 0 are actually allocated. Additionally, RBG 1 can correspond to VRBs 3, 4, 5, and 6 of the active BWP and be associated with a bitmap value of “0” in DCI as well as PRBs 3, 4, 5, and 6 in which the VRBs of the RBG 1 are not allocated. RBG2 can correspond to VRBs 7, 8, 9, and 10 of the active BWP and be associated with a bitmap value of “1” in DCI as well as PRBs 7, 8, 9, and 10 in which the VRBs of the RBG 2 are actually allocated. RBG 3 can correspond to VRBs 11, 12, 13, and 14 of the active BWP and be associated with a bitmap value of “1” and PRBs 11, 12, 13, and 14 in which the VRBs of the RBG 3 are actually allocated. RBG 4 can correspond to VRBs 15, 16, 17, and 18 of the active BWP and a bitmap value of “0” as well as PRBs 15, 16, 17, and 18 in which the VRBs of the RBG 4 are not allocated. RBG 5 can correspond to VRBs 19, 20, 21, and 22 of the active BWP and be associated with a bitmap value of “0” as well as PRBs 19, 20, 21, and 22 to which the VRBs of RBG 5 are not allocated. RBG 6 can correspond to VRBs 23 and 24 of the active BWP and be associated with a bitmap value of “1” in DCI as well as PRBs 23 and 24 in which the VRBs of RBG 6 are actually allocated.

Accordingly, the rbgBitmap for the configuration of FIG. 13 (e.g., “config2”) can be associated with a rbgBitmap=1011001 (in VRB order). Furthermore and as illustrated by FIG. 13, for NR PDSCH FDRA type-0, the VRBs to PRBs can be considered to have one-to-one mapping due to NR PDSCH FDRA type-0 using non-interleaved VRB allocation.

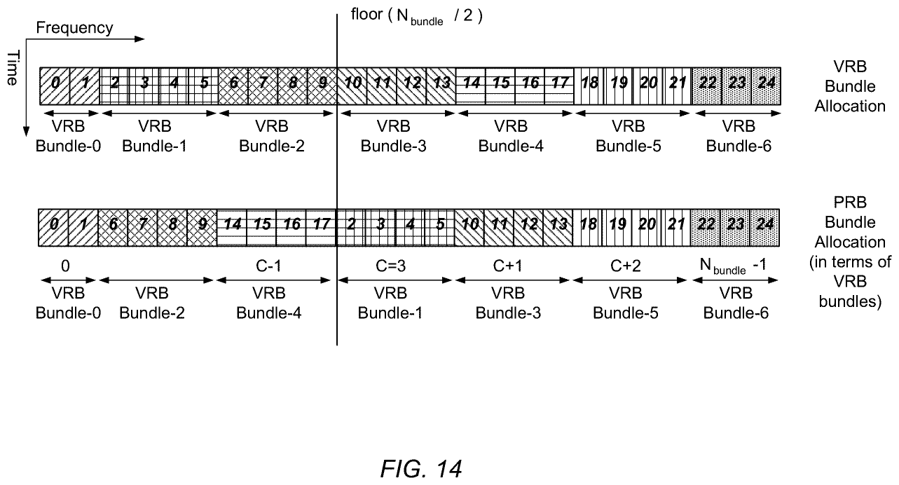

FIG. 14 illustrates an example of resource allocation type-1, according to some embodiments. In some embodiments, FIG. 14 illustrates an example of NR PDSCH FDRA Type-1 with interleaving enabled and actual PRB allocation based on the methods of FIGS. 12A-12D (e.g., methods 1200a, 1200b, 1200c, and 1200d) which can compute PRB Bundle Allocation (in terms of VRB bundles), according to some embodiments. For example, an active bandwidth part (BWP) of the common RBs 0-31 can correspond to VRBs 0 to 24 associated with a N_BWP_size of 25 (e.g., N_BWP_size=25), according to some embodiments. According to some configurations, the starting VRB (e.g., N_BWP_start) can be equal to 2 and the PDSCH allocation can be equal to 25 VRBs. Furthermore and according to the configuration, the VRB-to-PRB mapping bit indicated via DCI signaling can be equal to 1 which can indicate that interleaving is enabled, according to some embodiments. Additionally, the resource bundle size (“L”) can be equal to 4 RBs (e.g., as indicated by vrb-ToPRB-Interleaver). Furthermore, the configuration can specify the number of VRB bundles (e.g., N_bundle) is equal to 7, the VRB bundle-first size is equal to 2 VRBs, the VRB bundle-last size is equal to 3 VRBs and the remaining VRB bundle sizes are equal to 4 VRBs. Additionally, a floor function can specify a lowest integer number of VRB bundles associated with the configuration. For example, for N_bundle=7, floor (N_bundle/2) can correspond to a value of 3. According to some embodiments, the function floor (N_bundle/2) can be defined as “C” in the VRB to PRB mapping procedure in 3GPP specifications.

According to the aforementioned configuration and as illustrated by FIG. 14, VRB Bundle-0 can include RBs 0 and 1, VRB Bundle-1 can include RBs 2, 3, 4, and 5, VRB Bundle-2 can include RBs 6, 7, 8, and 9, VRB Bundle-3 can include RBs 10, 11, 12, and 13, VRB Bundle-4 can include RBs 14, 15, 16, and 17, VRB Bundle-5 can include RBs 18, 19, 20, and 21, and VRB Bundle-6 can include RBs 22, 23 and 24 as part of its VRB Bundle Allocation.

After the VRB-to-PRB mapping, the PRB Bundle Allocation in terms of VRB Bundles (e.g., the NR PDSCH allocation in PRB order) can be computed using the method described with respect to FIG. 9 (e.g., method 900). According to some embodiments, the odd VRB bundle indices (e.g., 1, 3, 5, . . . ) can be mapped to contiguous PRB bundle indices=C, C+1, C+2, . . . . Additionally, the even VRB bundle indices (e.g., 0, 2, 4, . . . ) can be mapped to contiguous PRB bundle indices=0, 1, 2, . . . , C−1. Additionally, for example since N_bundle=7 is odd, the last VRB bundle can be mapped one-to-one to the PRB bundle at bundle index= (N_bundle−1). This mapping procedure can be defined in 3GPP specifications. For example, upon using one or more of the methods described here (e.g., FIGS. 12A-D) with the aforementioned configuration of FIG. 14, the PRB Bundle Allocation in terms of VRB Bundles can result in VRB Bundle-0 being followed by VRB Bundle-2 (e.g., RBs 6, 7, 8, and 9), then VRB Bundle-4 (e.g., RBs 14, 15, 16, and 17), then VRB Bundle-1 (e.g., RBs 2, 3, 4, and 5), followed by VRB Bundle-3 (e.g., RBs 10, 11, 12, and 13), then VRB Bundle-5 (e.g., RBs 18, 19, 20, 21), and finally VRB Bundle-6 (e.g., RBs 22, 23, and 24).

### Additional Information

FDRA computation is one method for processing of 5G NR PDSCH in a 5G NR UE. FDRA computation can be done after DCI parsing and can be followed by parameter expansion of related 5G NR PDSCH parameters from the parsed DCI, rate-matching (e.g., NR PDSCH resource mapping), demodulation and decoding of 5G NR PDSCH which can be critical for 5G NR PDSCH processing.

Accordingly, the methods described in FIGS. 8-12 to detect and compute downlink resource blocks for allocated 5G NR PDSCH in frequency domain for both resource allocation type-0 and type-1 schemes can be executed in an optimal number of cycles and thereby allowing for a more optimal performance in a 5G NR UE. For example, the methods provide for enhanced efficiency by supporting binary integer arithmetic and logical operations at a time complexity of O(1) and are efficiently designed for a 32-bit architecture which can result in less power consuming methods during execution. Furthermore, the methods described in FIGS. 8-12 have a consistent and unified flow which can allow for reuse of variables and data structures. This can increase the efficiency for a software (SW) or hardware (HW) implementation with less storage memory being utilized and therefore leading to less power consumption. Thus, the proposed FDRA computational methods described herein can be implemented in SW and/or on HW for a given 5G NR UE as per the UE's performance power area (PPA) need.

According to some embodiments, the methods described herein can include ALU operations selected for improving the number of cycles for execution on a processor or HW supporting binary integer arithmetic and logical operations. The ALU operations can be limited to addition, subtraction, multiplication, bit shift and bitwise AND/OR/NOT operations. Additionally, mathematical operations such as division, ceil of a division, logarithm to base-2 and modulo can be realized via improved ALU operations with time complexity of O(1) to make the methods described herein more efficient in execution. For example, min (numRBs, L_RBs) as described with regard to FIGS. 12A-D can correspond to finding a minimum between numRBs and L_RBs. Furthermore, the minimum can be implemented using chosen ALU operations such as addition, subtraction, bit shift and bitwise AND operations with a time complexity of O(1), according to some embodiments.

For example, in the methods described herein, the division operation is designed using a 32-bit unsigned binary integer division method with a time complexity of O(1) to make it more efficient for a processor or HW supporting 32-bit architecture and thereby efficiently allowing resource allocation methods for type-0 and type-1 to compute and store RB bitmaps as nine 32-bit words. Along with the ALU operations, the methods described herein can include only the minimum required number of branch operations to achieve an optimal number of cycles for execution on a processor or HW. The branch operations can be indicated as rhombus-shaped decision blocks in the Figures, according to some embodiments.

According to some embodiments, the resource allocation type-0 and type-1 methods described herein can prepare and update input parameters (rbBitMask, rbStartPosition, numRBs and address to rb_bitmap array) required for execution at different stages in the method flow. For example, the ALU operations used in the preparation of input parameters and post-processing of output parameters from the method of FIG. 9 (e.g., method 900) can be consistent across both the resource allocation type-0 and type-1 methods. Also, both the methods can have a coherent approach in performing iterative calls to the method of FIG. 9 (e.g., method 900) to eventually derive and store a RB bitmap as nine 32-bit words, according to some embodiments.

According to some embodiments, the input parameters required for execution of the method of FIG. 10 (e.g., method 1000) can be derived from RRC IEs and BWP information obtained via initial access and RRC connection establishment 5G NR UE procedures. Furthermore, the outputs from the method of FIG. 10 (e.g., method 1000) can be used further in configuring the loops for each iterative call of the method of FIG. 9 (e.g., method 900), preparation of input parameters for method 900, and in the case of the type-1 interleaved method, to execute the flows for computation of VRB bundles, VRB bundle parameters, VRB to PRB mapping parameters and PRB bundles, according to some embodiments.

According to some embodiments, a method can include receiving, from a network node, signaling comprising a field including an indication of a resource allocation type for allocated physical downlink shared channel (PDSCH) resources in a downlink (DL) slot. The method can further include determining, based on the indication, the resource allocation type and computing, using a method for the determined resource allocation type, an order of physical resource blocks (PRBs) for the allocated 5G NR PDSCH resources. Additionally, the method can utilize a first method to compute a resource block (RB) bitmap for the determined resource allocation type and a second method to compute resource block group (RBG) parameters or resource block bundle (RBB) parameters for the determined resource allocation type. The method can further include communicating, according to the order of PRBs for the allocated 5G NR PDSCH resources, with the network node.

In some embodiments, the determined resource allocation type can be resource allocation type-0 or resource allocation type-1. Additionally, the first and second methods can be compatible with both resource allocation type-0 and resource allocation type-1. According to some embodiments, the signaling can be downlink control information (DCI) or radio resource control (RRC) signaling.

According to some embodiments, the first method can utilize arithmetic logical unit (ALU) operations including at least one of addition, subtraction, bit shift, or bitwise AND, OR, or NOT operations. Additionally, the first method can be utilized, as part of the method, for multiple iterations to compute and update the RB bitmap for a maximum of 275 PRBs associated with a 32-bit word comprising an array of nine elements. Furthermore, the first method can utilize at least one of rbStartPosition, numRBs, or rbBitMask input parameters. According to some embodiments, if the number of PRBs exceed a boundary of the 32-bit word, the method can be used to update both lower and upper 32-bit words to compensate for crossover across the word boundary.

According to further embodiments, the second method can compute, as part of the method, a modulo operation with an input nominal size number “L” being a power of 2, using ALU operations including at least one of subtraction or bitwise AND to derive other parameters including a modulo mask and a modulo result. Additionally, the second method can compute ceil of a division operation efficiently using parameters modulo mask, modulo result and a logarithm to base-2 operation, according to some embodiments. Additionally, the second method can utilize, as part of the method, a look-up table to implement a logarithm to base-2 operation. Furthermore, the second method can utilize at least one of N_BWP_start, N_BWP_size, rbg-size or vrb-ToPRB-Interleaver input parameters derived from the signaling.

According to some embodiments, the RB bitmap can be an array of nine 32-bit words. Furthermore, the first and second methods can utilize ALU operations for preparation of input parameters and post-processing of output parameters, according to some embodiments.

Embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Any of the methods described herein for operating a user equipment (UE) can be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

A further example embodiment can include a method, comprising: performing, by a wireless device, any or all parts of the preceding examples.

Another example embodiment can include a device, comprising: an antenna; a radio coupled to the antenna; and a processor operably coupled to the radio, wherein the device is configured to implement any or all parts of the preceding examples.

A further example set of embodiments can include a non-transitory computer accessible memory medium comprising program instructions which, when executed at a device, cause the device to implement any or all parts of any of the preceding examples.

A still further example set of embodiments can include a computer program comprising instructions for performing any or all parts of any of the preceding examples.

Yet another example set of embodiments can include an apparatus comprising means for performing any or all of the elements of any of the preceding examples.

Still another example set of embodiments can include an apparatus comprising a processor configured to cause a wireless device to perform any or all of the elements of any of the preceding examples.

Furthermore, it is well understood that the use of personally identifiable information can follow privacy policies and practices that are generally recognized as meeting or exceeding industry or governmental requirements for maintaining the privacy of users. In particular, personally identifiable information data can be managed and handled so as to minimize risks of unintentional or unauthorized access or use, and the nature of authorized use can be clearly indicated to users.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
establishing a wireless link with a Fifth Generation (5G) New Radio (NR) network node;
receiving, from the 5G NR network node, signaling comprising a field including an indication of a resource allocation type for allocated 5G NR physical downlink shared channel (PDSCH) resources in a downlink (DL) slot;
determining, based on the indication, the resource allocation type;
performing, using one or more first input parameters, a first computation of a resource block (RB) bitmap for the determined resource allocation type;
performing, using one or more second input parameters, a second computation of at least one of resource block group (RBG) parameters or resource block bundle (RBB) parameters for the determined resource allocation type;
performing, using one or more third input parameters, the RB bitmap, and at least one of the RBG or RBB parameters for the determined resource allocation type, a third computation of an order of physical resource blocks (PRBs) for the allocated 5G NR PDSCH resources; and
generating signaling for transmission to the 5G NR network node according to the order of PRBs for the allocated 5G NR PDSCH resources.

2. The method of claim 1, wherein the determined resource allocation type is resource allocation type-0 or resource allocation type-1.

3. The method of claim 1, wherein the first and second computations are compatible with both resource allocation type-0 and resource allocation type-1.

4. The method of claim 1, wherein the signaling comprises downlink control information (DCI) or radio resource control (RRC) signaling.

5. The method of claim 1, wherein the first computation utilizes arithmetic logical unit (ALU) operations including at least one of addition, subtraction, bit shift, bitwise AND, bitwise OR, or bitwise NOT operations.

6. The method of claim 1, wherein the first computation is utilized for multiple iterations to compute and update the RB bitmap for a maximum of 275 PRBs associated with a 32-bit word comprising an array of nine elements.

7. The method of claim 6, wherein the one or more first input parameters include at least one of:
one or more parameters specifying at least one of dimensions or characteristics of an array associated with the RB bitmap;
one or more parameters specifying a starting RB for the first computation;
one or more parameters specifying a total number of RBs for the first computation; or
one or more parameters specifying a mask of RBs associated with the RB bitmap.

8. The method of claim 6, wherein if a number of PRBs exceeds a word boundary of the 32-bit word, the first computation updates both lower and upper 32-bit words to compensate for crossover across the word boundary.

9. A processor, comprising:
memory storing instructions that, when executed, cause the processor to:
establish a wireless link with a Fifth Generation (5G) New Radio (NR) network node;
receive, from the 5G NR network node, signaling comprising a field including an indication of a resource allocation type for allocated 5G NR physical downlink shared channel (PDSCH) resources in a downlink (DL) slot;
determine, based on the indication, the resource allocation type;
perform, using one or more first input parameters, a first computation of a resource block (RB) bitmap for the determined resource allocation type;
perform, using one or more second input parameters, a second computation of at least one of resource block group (RBG) parameters or resource block bundle (RBB) parameters for the determined resource allocation type;
perform, using one or more third input parameters, the RB bitmap, and at least one of the RBG or RBB parameters for the determined resource allocation type, a third computation of an order of physical resource blocks (PRBs) for the allocated 5G NR PDSCH resources; and
generate signaling for transmission to the 5G NR network node according to the order of PRBs for the allocated 5G NR PDSCH resources.

10. The processor of claim 9, wherein the determined resource allocation type is resource allocation type-0 or resource allocation type-1.

11. The processor of claim 9, wherein the first and second computations are compatible with both resource allocation type-0 and resource allocation type-1.

12. The processor of claim 9, wherein the second computation utilizes at least one of the following to derive other parameters including a modulo mask and a modulo result:
a modulo operation;
an input nominal size being a power of 2;
a ceil of a division operation; or
arithmetic logical unit (ALU) operations including addition, subtraction, bit shift,
and bitwise AND.

13. The processor of claim 9, wherein the second computation utilizes a look-up table to implement a logarithm to base-2 operation.

14. The processor of claim 9, wherein the one or more second input parameters include at least one of:
one or more parameters specifying a starting RB for the second computation;
one or more parameters specifying a size of a bandwidth part (BWP) for the second computation;
one or more parameters specifying a size of a RBG for the second computation; or
one or more parameters specifying an interleaver size in terms of PRBs for interleaving virtual resource blocks (VRBs) and PRBs for the second computation.

15. The processor of claim 9, wherein the signaling comprises downlink control information (DCI) or radio resource control (RRC) signaling.

16. A non-transitory computer readable storage medium storing program instructions executable by one or more processors to:
establish a wireless link with a Fifth Generation (5G) New Radio (NR) network node;
receive, from the 5G NR network node, signaling comprising a field including an indication of a resource allocation type for allocated 5G NR physical downlink shared channel (PDSCH) resources in a downlink (DL) slot;
determine, based on the indication, the resource allocation type;
perform, using one or more first input parameters, a first computation of a resource block (RB) bitmap for the determined resource allocation type;
perform, using one or more second input parameters, a second computation of at least one of resource block group (RBG) parameters or resource block bundle (RBB) parameters for the determined resource allocation type;
perform, using one or more third input parameters, the RB bitmap, and at least one of the RBG or RBB parameters for the determined resource allocation type, a third computation of an order of physical resource blocks (PRBs) for the allocated 5G NR PDSCH resources; and
generate signaling for transmission to the 5G NR network node according to the order of PRBs for the allocated 5G NR PDSCH resources.

17. The non-transitory computer readable storage medium of claim 16, wherein the determined resource allocation type is resource allocation type-0 or resource allocation type-1.

18. The non-transitory computer readable storage medium of claim 16, wherein the first and second computations are compatible with both resource allocation type-0 and resource allocation type-1.

19. The non-transitory computer readable storage medium of claim 16, wherein the RB bitmap comprises an array of nine 32-bit words.

20. The non-transitory computer readable storage medium of claim 16, wherein the first and second computations utilize arithmetic logical unit (ALU) operations for preparation of the first and second input parameters and post-processing of output parameters.
